(19) United States
(12) Patent Application Publication
(10) Pub. No.: US 2007/0106552 A1
(43) Pub. Date: May 10, 2007

(54) Government systems in which individuals vote directly and in which representatives are partially or completely replaced

(76) Inventor: Jeffrey A. Matos, New Rochelle, NY (US)

Correspondence Address: MILDE & HOFFBERG, LLP, 10 BANK STREET, SUITE 460, WHITE PLAINS, NY, 10606, US

(21) Appl. No.: 11/595,655

(22) Filed: Nov. 9, 2006

Related U.S. Application Data
(60) Provisional application No. 60/735,109, filed on Nov. 9, 2005.

(51) Int. Cl. G07C 13/00

(52) U.S. Cl. 705/12

(57) ABSTRACT

Methods of government are presented which allow for the representation of the views of the constituents in substantially real time. These methods include approaches in which (1) all or (2) part of a representative's voting power is returned to the constituents represented. These methods further include approaches in which there may be either integral or fraction counting of representative's votes. These methods further include approaches to deal with the “abstention” by a representative. Examples are shown for the United States government, including methods in which (1) the entire legislature is replaced by a one-body or two-body direct voter legislature; (2) in which a direct voting 3rd legislative unit is established within the U.S. Congress; and (3) in which a 4th branch of the U.S. government, the direct voter branch, is added.

### BACKGROUND OF THE INVENTION

Representative forms of government entail the election of representatives who are then empowered to represent the views and desires of the constituents that they represent. The value of such an approach includes efficiencies in terms of time, space and, expense. Decisions made by representatives can, in principle, be made quickly and efficiently.

Much of the discussion that follows refers to the government of the United States. However, the methods which form the various embodiments of the current invention are equally applicable not only to the government of the United States, but equally so to

a) state governments;

b) city and town governments;

c) county governments

d) the United Nations;

e) the governments of other countries;

f) corporations and other organizations where leaders are intended to represent the views of other people within the organization.

Referring again to the United States government, an extraordinarily well thought out set of design features in the late eighteenth century has allowed it to continue to function since that time, now with slightly more than 500 individuals representing the views of 300,000,000. Occasional modifications since the writing of the Constitution, such as the Fourteenth Amendment, have allowed for changes which reflect an ongoing attempt to make the representative process as fair as possible.

In the United States government, for example, the voting public express their views by electing (a) a President and Vice President every four years, (b) Senators every six years, and (c) members of the House of Representatives every two years.

Problems with this approach include:

1) If the constituents' views on matters of importance—based on which they previously voted for and chose their elected representatives—changes during the two to six years of the term of the elected representative, the people whose view has changed may not be able to have the new view represented by the previously elected representative. The previously elected representative may be either unaware or unwilling to change his or her position in a way that one or more of their constituents have changed. When the number of such changed constituents is only a small fraction of the total constituents, the problem is less severe than when the number becomes a larger fraction or even a majority.

2) Each mechanism for making the will of the constituents known prior to the time of the next election has substantial inefficiencies. Letter writing is possible but seldom done, in part because many constituents believe it to be ineffective. At the other extreme is the attempted removal of a President or other representative from office before their term has expired. Such removals are very time consuming, and seldom, if ever accomplished, when the basis for removal is failure to accurately represent the views of the constituents.

3) Representatives, because they are so dependent on funding sources to finance future campaigns, may find it difficult to separate the motives of the funding source from positions on issues which would best represent the collective will of constituents.

4) When a representative must represent each of the views of a constituent, and when there are a variety of issues, there is the possibility, and even the likelihood, that the representative and the constituent may share identical views concerning some issues and opposing views concerning other issues. The table below shows a simple example of two candidates who may be running in an election, and their respective views concerning each of two issues.

| | ISSUE #1 | ISSUE #2 |
|---|---|---|
| CANDIDATE #1 | in favor | opposed |
| CANDIDATE #2 | opposed | in favor |

As can be seen from the table, a voter who is in favor of both issue #1 and issue #2 will not be able to select a candidate who adequately reflects his/her views. This forces the voter to support a position for issue #1 or #2 that is not his or her real choice. A direct voting system, in which the voter could separately vote for issue #1 and issue #2 would avoid the need for such a choice.
5) The nomination/candidate selection process is subject to a variety of flaws. Flaws in this nominee pre-selection process are then propagated, when the one such candidate—not necessarily the one who would have been the choice of direct voters—is selected as the nominee. A system in which direct voters are involved in nominee selection may result in a more appropriate selection.

When the United States Constitution was drafted in the late 18^{th} century, electronic communication was non-existent, and a method of government in which individuals with the right to vote participated directly would have been unworkable in a practical sense. In modern times, however, the ability to involve the population directly is entirely different than was the case during colonial times. Modern communication methods and the very broad availability of input devices including computer keyboards, telephones and other input devices allow for rapid determination of transmission of the views of the population about government matters.

It is therefore possible to continue the process begun by the Fourteenth Amendment to the U.S. Constitution and thereby allow the participation of direct voters in the U.S. government. The technology for accomplishing this, as well as for the accomplishment of direct voter participation in other forms of government and management systems, is now available.

### SUMMARY OF THE INVENTION

The present invention describes methodologies for the implementation of direct voting in a government or other organization.

One invention includes a method to allow an individual who is represented by a representative, to effectively “remove” an amount of voting power from that representative that is the equivalent of his vote, and to independently vote that one vote. One embodiment of the invention counts the vote of each representative, and voting district as either in favor of or opposed to proposed legislation.

Another embodiment allows for the counting of fractional district votes.

Still other embodiments allow for vote counting when one or more representatives abstain. Embodiments are presented in which an abstention is not counted as a vote; still other embodiments are presented in which an abstention is counted as an intentional expression of a neutral position concerning proposed legislation.

Direct voting methodologies, when there are two representatives for each voting district, such as in the United States Senate, constitute yet another embodiment of the invention. Examples are presented of such two-representative methodologies in which both of the aforementioned types of abstention may occur. Examples are presented of such two-representative methodologies in which district vote counting may be either integral or fractional.

Another embodiment of the invention is a government system which is structured in a manner similar to that of the United States government except that the legislative branch is replaced by a one-body direct voter branch. Methods by which the one-body may accomplish the tasks of a two-body system are discussed hereinbelow.

Another embodiment of the invention is a government system which is structured in a manner similar to that of the United States government except that the legislative branch is replaced by a two-body direct voter branch. In this embodiment, one of the bodies represents the voters in a manner analogous to the United States House of Representatives, while another body represents the voters in a manner analogous to the United States Senate.

Another embodiment of the invention is a government system which is structured in a manner similar to that of the United States government except that the legislative branch has three bodies including one in which the population is represented in a manner similar to that of the United States Senate, one in which the population is represented in a manner similar to that of the United States House of Representatives, and one in which the population is represented by direct voters. Methods by which the three bodies interact are presented.

Another embodiment of the invention is a government system which is structured in a manner similar to that of the United States government except that instead of only the three branches of government (the legislative, executive and judicial branches), there is a four-branch government, including the aforementioned three branches and a fourth, direct voter branch. This embodiment includes methods of interaction between the various branches, such as methods of veto and veto override that are more complex than such methods in a three-branch government. The abundance of permutations of such interactions in a four branch government, with the number of such permutations exceeding that for a three branch government, allows for an even greater number of “checks and balances” (i.e. the methodology which prevents any one branch from becoming excessively powerful and/or acting inappropriately). Examples of such checks and balances are presented hereinbelow.

For each of the government systems, methods are presented by which the direct voters may (a) select an individual to represent them in a discussion or a negotiation, or any other activity involved in the entire process of the generation of legislation, from its conception to its acceptance; and (b) select one piece of legislation from others, or select a concept or principle to be part of a piece of legislation. Methods are presented in which such selection occurs in a single voting process, a two step process, or a many step process.

### BRIEF DESCRIPTION OF THE DRAWINGS

FIG. 1a is a flow diagram for determining how both representatives and direct voters may vote on proposed legislation, and the method for determining whether such legislation is accepted, in the case where only integral votes are counted for a voting district.

FIG. 1b is a flow diagram for determining how both representatives and direct voters may vote on proposed legislation, and the method for determining whether such legislation is accepted, in the case where the representative may abstain from voting.

FIG. 2 is a flow diagram for determining how both representatives and direct voters may vote on proposed legislation, and the method for determining whether such legislation is accepted, in the case when fractional votes may be counted for a voting district.

FIG. 3 is a flow diagram for determining how both representatives and direct voters may vote on proposed legislation, and the method for determining whether such legislation is accepted, in the case of fractional or integral votes for a voting district in which there are two representatives.

FIG. 4 is a flow diagram of a legislature with three branches: a senate, a house of representatives, and a direct voter branch.

FIG. 5 is a flow diagram of a government system with a one-body direct voting legislature, an executive branch, and a judicial branch.

FIG. 6 is a flow diagram of a government system with a two-body direct voting legislature, an executive branch, and a judicial branch.

FIG. 7 shows a government with four branches: an elected legislature, an executive branch, a judicial branch and a direct voter branch.

### DETAILED DESCRIPTION OF THE PREFERRED EMBODIMENTS

Hereinbelow and hereinabove, gender is referred to as male, without the intent being to limit the reference to the male gender or to indicate a preferred gender in the methodology, the voting process, or any process related to the voting process.

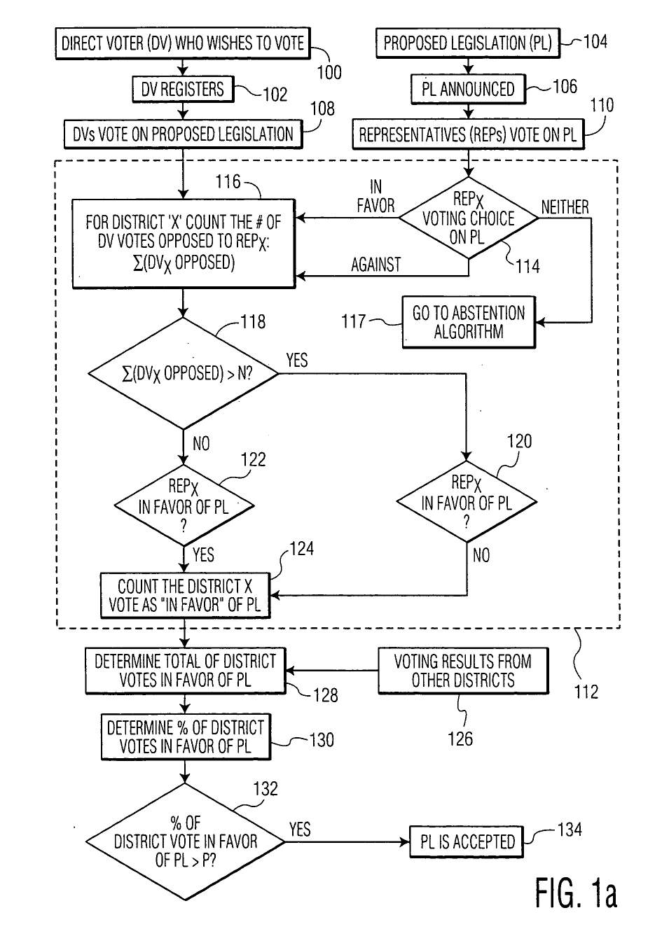

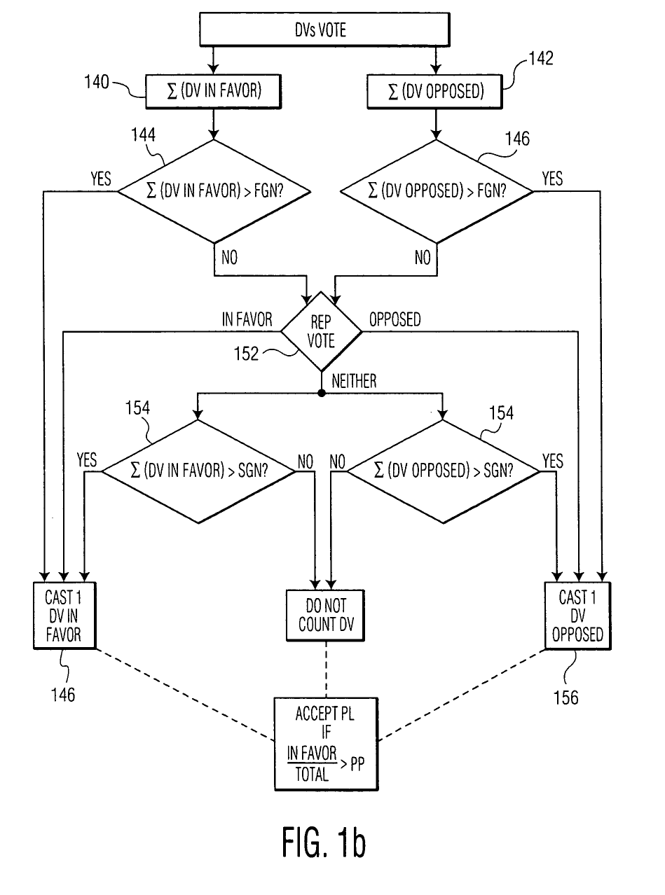

Referring to FIG. 1a, the assumptions and the calculations based on these assumptions, underlying one method for the concurrent voting of both direct voters and elected representatives is shown in Appendix 1, hereinbelow.

The basic concept is that each representative represents all or substantially all of the residents in the district represented. The definition of “resident” is expected to be in concert with the laws of the appropriate jurisdiction or entity, whether that jurisdiction is a voting district for a Representative in the U.S House of Representatives, or a voting district in a state, a city, or a shareholder or “member” of a large organization.

In the embodiment of the invention presented in FIG. 1a, if a direct voter chooses to express his own vote, that one vote is subtracted from the “voting constituency” represented by the representative. For example, if the representative represents 1000 residents, and one of the eligible residents becomes a direct voter, the direct voter represents his one vote and, as the representative represents the remaining 999 votes. If 501 residents become direct voters, the 501 each vote their one vote, and the representative vote counts for the remaining 499 residents.

A resident who wishes to directly represent himself, block 100, may do so, if (a) he is eligible to vote; and (b) if he properly registers, block 102. The voting will concern proposed legislation 104, which is announced 106, and thereby made available to both the direct voter (“DV”) and the representative (“REP”).

At the appropriate time, or during the appropriate time interval, the DVs vote 108, and the REPs vote 110. Embodiments of the invention are possible where the REPs vote first, where the DVs vote first, and where there is no particular order. There needs to be a time limitation to the vote of either the DV or the REP, in order that legislation be considered and acted upon in a timely manner.

Appendix 1 shows that for the DVs to dominate the voting in a particular district, more than half of the residents in the district must be DVs who select the same position. In such a case, the DV choice “wins” regardless of the choice of the REP.

The most general statement of how the DV vote is to be counted is to state that the DVs dominate the election if their vote count exceeds the number “N.” The laws of the jurisdiction will determine the value of N. The value of N may vary depending on the proposed legislation (“PL”). For example, if the PL is an appropriations bill, the value of N may be the number which is half the number of residents in the district. Alternatively, if the PL is the override of a presidential veto, the value of N may be the number which is two thirds of the number of residents in the district.

Referring again to FIG. 1a, the elements within the dashed line 112 indicate the events which occur in one voting district among a plurality of districts. The totality of these events will determine how the one district vote is to be assigned, i.e. either in favor of, or against the PL. The totality of the district votes will determine whether the PL is accepted by the legislative body. Within 112, and hereinabove and below, the subscript “X” refers to the entities within a given voting district: i.e. REP_{X} refers to the REP in district X and DV_{X} refers to the DVs in district X. The large Greek letter “sigma” refers to its traditional arithmetic use as a summation symbol. Thus, the summation in block 116 is the sum of all DVs who vote in district X and whose vote is opposed to that of the REP in district X.

The vote tabulation in district X is as follows. Note is made, block 114, of whether the district X REP votes in favor of, or in opposition to the PL. Based on this vote, the number of voting DVs in the district who are opposed to the position of the district REP is noted, block 116.

If the sum of opposed DVs in the district exceeds N, block 118, the opposed DVs dominate the voting, and the outcome will be a district vote opposite that of the district REP. Thus if the district REP is opposed to the PL, block 120, the district vote is assigned as being in favor of the PL, block 124. (To simplify the figure and the discussion, and without any loss of generality, in this particular case only the district vote in favor of the legislation is counted. This is sufficient as long as all districts vote. Thus, if the sum of the opposed voting DVs exceeds N and the REP's position is in favor of the PL, the district vote is against the PL. Although not tabulated in the figure, the number of votes opposed to the PL will be known, obtained by subtracting the number of district votes in favor from the total number of district votes.)

IF the sum of the opposed voting DVs does not exceed N, block 118, and the REP's position is in favor of the PL, block 122, the district vote is counted as being in favor the PL, block 124. (And as implied by the text hereinabove, if the sum of the opposed voting DVs does not exceed N, block 118, and the REP's position is in opposition to the PL, the district vote is not counted as in favor of the PL.)

The process inside of box 112 is carried out in each voting district within the jurisdiction, and the “in favor” votes from districts other than X are noted, block 126, and are added to the “in favor” vote, if any, of district X, block 128. The percentage of districts in favor of the PL, block 130, is determined by calculating 100 times the fraction whose numerator is the number of districts in favor, and whose denominator is the number of districts (which, as indicated hereinabove, for the purpose of this calculation is assumed to be equal to the total number of district votes). If, block 132, the percentage exceeds the value P, then the PL is considered to be accepted, 134, by the legislative body. P may be 50%, e.g. for issues that generally require a simple majority, and may be 66⅔% (or some other value which is more than 50%) for issues of major importance.

The above method of counting is not unique for a system in which a registered resident may vote his own vote. For example, instead of counting the votes of DVs opposed to the REP, it would have been possible to start (and possibly to complete the process) by counting the votes of DVs in support of the REP. It would also be possible to (a) determine the number of DVs, (b) subtract this number from the number of residents represented by the REP, (c) count the number of votes in favor of the PL from among the REP and the DV, and (d) if the sum in (c) exceeds N, then the district vote is assigned as in favor of the PL. Still other sequences of arithmetic steps are possible. Each of these approaches, based on the assumption that one voting DV represents his own vote, and the REP represents all residents except the voting DVs, yields the same numerical counts, and the same voting outcome.

In an alternative embodiment of the invention, it may be deemed appropriate to allow the voting position of the DVs to dominate the voting process (i.e. to impose their wishes regarding the PL, even if they are in opposition to the REP if the number of DVs taking a particular position is greater than either (a) half the number of registered DVs, or (b) half the number of registered DVs who vote on a particular piece of PL.

The situation in which the REP is neither opposed to nor in favor of the PL (block 114 leading to 116) may be dealt with in a number of ways:

(a) The position favored by a majority of DVs may be assigned as the district vote, as long as the total number of DV votes exceeds a first given minimum. Examples of such minima are (i) one half the number of registered DVs in the district, (ii) one half the number of registered DVs voting in the current PL vote, and (iii) one half the number of residents in the district. The requirement of (iii) hereinabove is the arithmetic equivalent of the statement that an abstention by the REP implies the REPs intention to vote a neutral position. In this scenario, if each DV vote is assumed to represent one resident and if the REP vote is assumed to represent all residents who are not DVs voting on the current matter—then a district vote in favor of the PL will require that a DV position in favor of the PL must have the support of at least half the number of residents, each of whom vote directly in favor of the PL; The majority may be a simple majority or may involve a greater degree of support.

(b) The position favored by a majority of DVs may be assigned as the district vote, as long as the number of DV votes exceeds a second given number. The majority may be a simple majority or may involve a greater degree of support. FIG. 1b, shows another algorithm which incorporates abstention into the voting methodology described hereinabove. The DV votes in favor of 140, and opposed to 142 the PL are counted. If the quantity at block 140 exceeds a first given number (“FGN”), block 144, the district vote is counted as “in favor.” (block 146). An example would be if the FGN exceeds half the number of district residents, with the reasoning being the same as in conjunction with FIG. 1a. If the quantity at block 142 exceeds FGN, block 148, the district vote is counted as “opposed.” (block 150).

If neither the quantity at block 140 nor the quantity at block 142 exceeds FGN then:

(a) if the REP voted, block 152, either for or against the PL, the choice of the REP becomes the choice of the district;

(b) if the REP abstained, then the DV will determine the district vote outcome, as long as the number of direct voters who voted exceeds a second given number (“SGN”), block 154. Examples of the SGN are (i) half the number of residents in the district, (ii) half the number of registered voters in the district, (iii) half the number of DVs who voted in the PL determination and (iv) the number one.

Other examples of choices for the FGN are (i) half the number of registered voters in the district, and (ii) half the number of DVs who voted in the PL determination.

After all of the district votes have been tabulated and summed, the percentage of district votes in favor of the legislation is determined to be the total number of votes in favor, multiplied by 100, divided by the total number of district votes cast. Examples of percentages which would be considered to define PL acceptance (block 156) are 50, 66⅔ and 75.

The aforementioned methodology assigns all of a district vote to one side, i.e. to the side either in favor of, or to the side which is opposed to the PL. However, it is possible that a series of “rounding off” errors which are implicit in the aforementioned “all-or-none” assignment of the district vote may result in a total vote which substantially fails to reflect the view of the majority of the residents of the jurisdiction. For example, if slightly more than half of the districts had 51% of their respective voters (including the votes represented by both DVs and REPs) in favor of a PL, and slightly less than half of the districts had 80% of their respective voters opposed to the PL, the PL would be accepted using the aforementioned methodology, despite the fact that only a minority of voters (“or voter-equivalents”, counting the votes of the REPs) in the jurisdiction are in favor of the PL.

The following methodology describes a system where fractional district votes are counted. The concept that the REP is, in effect, a proxy for all of the non DV residents of the REPs district, is not changed herein; nor is the concept that a vote by a DV subtracts one vote-equivalent from that voted by the REP.

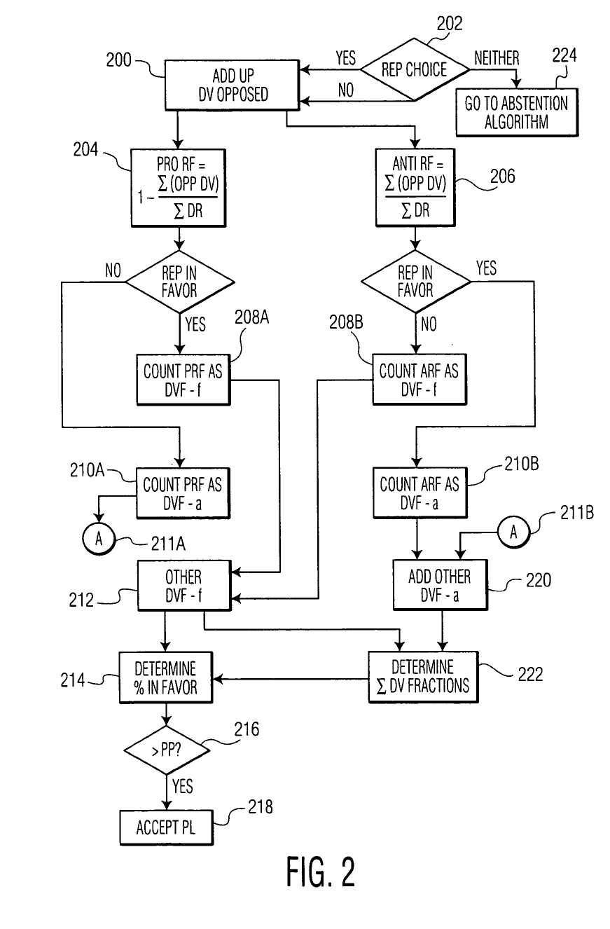

The initial phase of the voting and registration proceeds in a substantially similar manner to that described hereinabove for integral district votes, in conjunction with FIG. 1a. FIG. 2 shows that the DV vote opposed to the position of the REP is totaled, block 200, based on the choice of the REP, block 202. The anti-representative fraction (“ARF”), block 204, is defined as the number of DV votes opposed to the REP's position divided by the number of residents (as defined hereinabove) in the district. The pro-representative fraction (“PRF”) is defined as the number 1 minus the ARF.

The fraction of the district vote in favor of the PL, block (“FDV-f”), is then determined to be (i) the PRF for the district, if the district REP voted in favor of the PL (block 208A), and (ii) the ARF for the district, if the district REP voted against the PL (block 208B).

The fraction of the district vote against the PL (“FDV-a”) is then determined to be (i) the PRF for the district, if the district REP voted against the PL (block 210A), and (ii) the ARF for the district, if the district REP voted in favor of the PL (block 210B).

Finally, the fractional district votes in favor of the legislation for each district are added (block 212); the result may be multiplied by 100 and divided by the total number of district votes, to obtain a percentage (block 214). If the percentage exceeds a given value (block 216) e.g. 50, 66⅔, 75, the PL is considered to be accepted (block 218). If the voting rules specify that all districts must vote, then the total district votes will be the number of districts. If not, then the total district votes will be the sum of (a) the FDV-a's (blocks 210A to 211A to 211B to 220 to 222 and block 210B to 220 to 222) and (b) the FDV-f's for all districts which voted.

If the REP does not vote, block 224, there are two ways by which his abstention may be handled:

a) If it is assumed that a non-vote is the equivalent of a “no-show,” and the abdication of his responsibility, the entire district vote may be placed in the domain of the DVs. In such a case, FDV-f is determined to be the fraction of the voting DVs who are in favor of the PL;

b) If, instead, it is assumed that a non-vote is the equivalent of a “neutral position,” and a non-favoring of both of the pro PL the anti-PL positions, then it may be assumed that the REP has not abdicated his responsibility, and wishes to use his voting power to support a neutral position. In such a case, the voting DVs do not (as in the case hereinabove) vote for the entire district; they vote only their own vote. As such the denominator for the FDV-f and FDV-a is the total number of residents in the district; the numerator is the number of DVs supporting the respective position with respect to the PL.

Additional arithmetic complexities arise when one considers the complexities of direct voters voting their own “share” of the vote in a scenario where their district has two representatives. An example of this would be a state in the U.S. which has two Senators. First, complexities arise because the senators may or may not vote for the same position. Second, additional complexities arise when abstentions are considered. In the discussion that follows, reference is made to Senators, without intending to be so specific that the only entities referred to are States in the United States.

One way of dealing with the complexities would be to divide each state in two, based either or geographic or population considerations. The situation would then be conceptually identical to that discussed hereinabove.

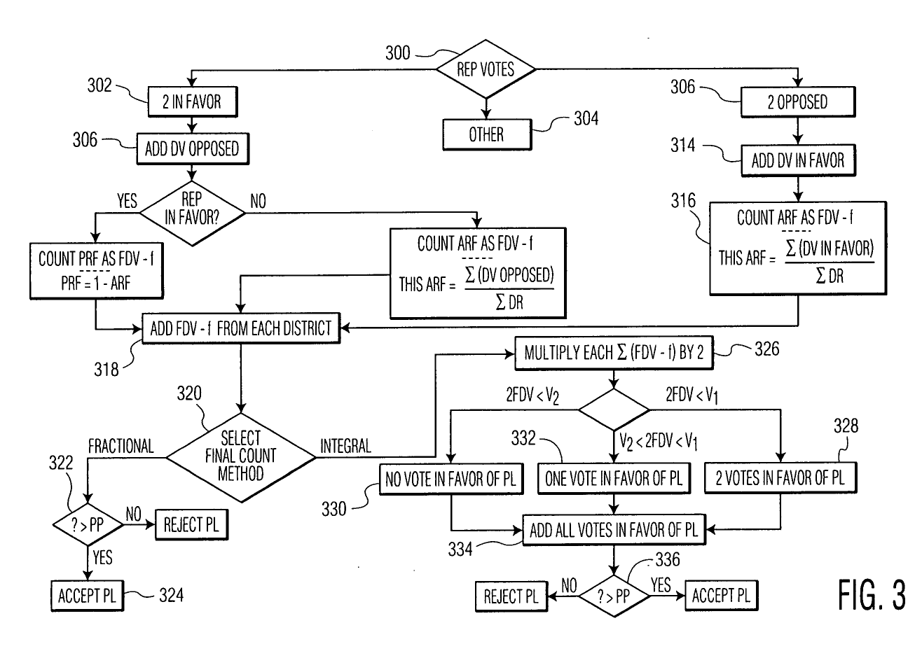

When such a division does not occur, FIG. 3 illustrates how the voting is to be analyzed.

The two senators may vote at 300. If they both vote, and their votes are in agreement, 302, the total number of DVs who vote who are opposed to the REPs' position is totaled 306. The district ARF is then determined as the total of block 306 (district oppositional DVs) divided by the number of district residents (“DRs”). The district PRF is then determined to be the number one minus the ARF. Next, the FDV-f is determined to be: (i) the PRF if both senators voted in favor of the PL, and (ii) the ARF if both senators were opposed to the PL.

If the senators take opposing positions, 306, regarding the PL, then the FDV-f, 316, is the fraction whose numerator is the number of voting DVs in favor of the PL, 314, and whose denominator is the number of DRs.

The aforementioned FDV-f's are summed, 318, for all senatorial districts.

Two methods are presented for converting the sum of the FDV-f's to a final senate decision. If the decision, 320, is to retain the fractional counts, then the sum of fractional counts in favor is divided by the number of district votes, and if a prescribed percentage (e.g. 50 or 66⅔), block 322, is exceeded, the PL is accepted, 324.

If, instead, the decision is made to convert each state's FDV-f to an integral vote, the state vote is multiplied by the number 2, block 326. A decision is made as to what will be the cutoff for counting 2 votes (2 times FDV-f>V1) in favor of the PL, block 328, what will be the cutoff for counting 0 votes in favor of the PL (2 times FDV-f<V2), block 330, and the scenario for a count of 1 vote in favor of the PL (V2<2 times FDV-f<V1), block 332. An example of values of V1 and V2 are 4/3, and ⅔. Another example is 3/2, and ½.

Each of the integral votes in favor of the PL is then added, 334, and the sum is divided by the total number of votes. If the number exceeds a prescribed percentage—e.g. 50 or 66⅔, the PL is accepted, block 336.

If, block 304, one or more of the senators abstains, then the two possible considerations for the meaning of an abstention (presented hereinabove) come into play. “No show” type abstentions are treated as if the senators votes are to be given to the direct voters, whereas “intentionally neutral” type abstentions are treated as if the senator voted half of “his vote” (i.e. the number of residents minus the number of DVs voting in this voting procedure, divided by the number of residents) in favor of, and half of “his votes” against the proposed PL.

The result is that there are three ways in which two abstentions may be considered, and two ways in which a single abstention may be considered.

For one abstention situations, the results are:

(a) single senator in favor of PL, and a single senator abstains as “intentionally neutral:”

FDV-f numerator=(i) sum of DR plus (ii) sum of DVs who voted minus (iii) two times the sum of the DVs who voted in opposition to the senator;

FDV-f denominator=2 times sum of DR.

The FDV-f numerator divided by the FDV-f denominator gives the FDV-f for the given district. This value is added to the sum in block 318.

(b) single senator in against PL, and a single senator abstains as “intentionally neutral:”

FDV-f numerator=sum of the DVs who voted in opposition to the senator;

FDV-f denominator=sum of DR.

The FDV-f numerator divided by the FDV-f denominator gives the FDV-f for the given district. This value is added to the sum in block 318.

(c) single senator in favor of PL, and a single senator abstains as a “no show:”

FDV-f numerator=(i) two times the sum of DVs who voted minus (iii) the sum of the DVs who voted in opposition to the senator;

FDV-f denominator=2 times sum of voting DVs.

The FDV-f numerator divided by the FDV-f denominator gives the FDV-f for the given district. This value is added to the sum in block 318.

(d) single senator against PL, and a single senator abstains as “no show:”

FDV-f numerator=the sum of the DVs who voted in opposition to the senator;

FDV-f denominator=2 times sum of the voting DVs.

The FDV-f numerator divided by the FDV-f denominator gives the FDV-f for the given district. This value is added to the sum in block 318.

For situations in which both senators abstain:

(a) two “intentionally neutral” abstentions:

FDV-f numerator=the sum of the DVs who voted in favor of the PL;

FDV-f denominator=the sum of the DR

The FDV-f numerator divided by the FDV-f denominator gives the FDV-f for the given district. This value is added to the sum in block 318.

(b) two “no show” abstentions:

FDV-f numerator=the sum of the DVs who voted in favor of the PL;

FDV-f denominator=the sum of the DVs who voted

The FDV-f numerator divided by the FDV-f denominator gives the FDV-f for the given district. This value is added to the sum in block 318.

(c) one “intentionally neutral” abstention and one “no show” abstention:

FDV-f numerator=the sum of (i) the DVs who voted in favor of the PL plus (ii) 2 times the sum of the voting DVs in favor of the PL;

FDV-f denominator=4 times the sum of the DV who voted

The FDV-f numerator divided by the FDV-f denominator gives the FDV-f for the given district. This value is added to the sum in block 318.

Without substantially altering the conceptual underpinning, the calculations hereinabove may be modified as to:

(a) the order of operations (but without changing algebraic consequences)

(b) the naming of terms.

Furthermore, other ways of conceptualizing the philosophical implications of an abstention will be apparent to those skilled in the art, so that the above results are not intended to be an exhaustive catalog of the algebraic analysis of voter abstention. It is nevertheless, intended that abstentions be taken into consideration as part of the preferred embodiments of the inventions.

The discussion heretofore addresses the situations in which direct voters may vote part of a voting position of a representative. In that “regime”, only if the representative does not vote, and then only under certain circumstances, may the direct voters have a full district or senate vote.

The following discussion addresses direct voter inventions in which the direct voters form a complete branch or part of a branch of government.

Third Branch of Legislature

In a system of government whose structure is similar or equivalent to that of the U.S., i.e. as including an executive branch, a legislative branch and a judicial branch, this embodiment has a legislative branch with three bodies:

a) One body in which the population of each state (the entire jurisdiction consisting of two or more states) is represented by each of two elected representatives, said representatives voting on legislation affecting the jurisdiction;

b) One body in which the population of each district (each state consisting of at least one district, with the number of districts in a state approximately proportional to the population of the state) is represented by one elected representative, said representatives voting on legislation affecting the jurisdiction; and

c) One body in which individuals throughout the jurisdiction vote directly. Electronic means, as are known in the art, are used to communicate the votes of such individuals. Such means may include a computer attached to the internet, a telephone device, a public or private communication means. In a preferred embodiment of the invention, in order to vote, the individuals must be residents of the jurisdiction, who have registered to vote. Confirmation means may be used to assure that the registered voter's vote was received; additional confirmation means may be used to allow the individual to confirm that his vote was properly received. Encryption and decryption means at each end of the communication system, as are known in the art, may be employed. Direct voting systems in which registered voters are not obligated to vote on all PL are possible. Direct voting systems in which all residents are considered to be direct voters without the requirement for registration are possible. Government systems are possible in which residents who do not own and/or cannot afford to own the appropriate communication device to allow them to vote are supplied with such equipment by either the government or private donors.

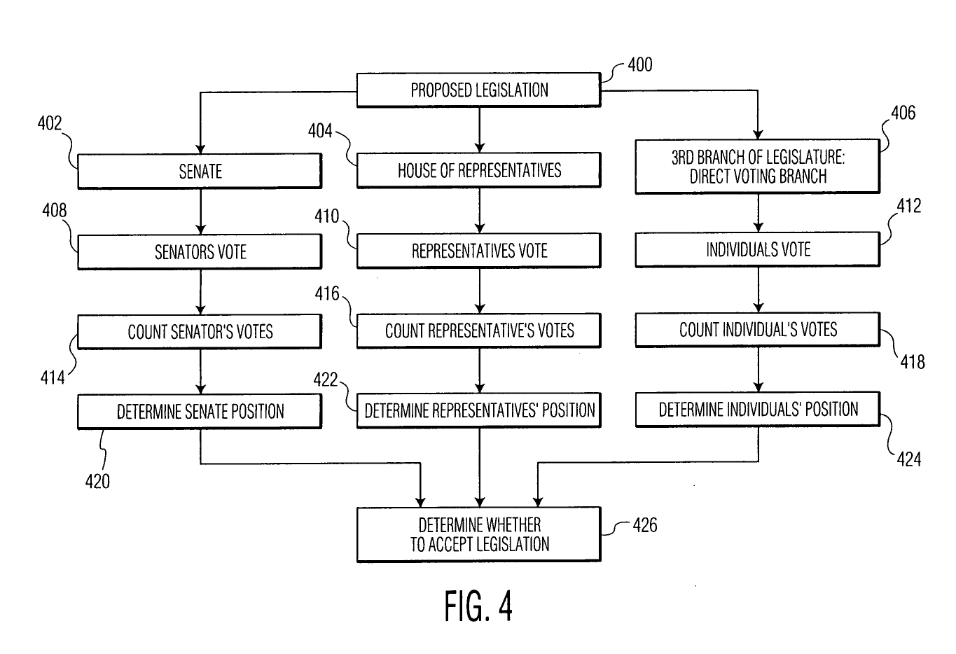

FIG. 4 illustrates an embodiment of this invention, as it might be structured if it were based on, or is an outgrowth of the legislature in the United States in 2006. Proposed legislation 400 is sent for consideration to each of:

(a) a senate 402;

(b) a house of representatives, 404; and

(c) a direct voting branch of the legislature 406.

After consideration of the PL, the senators vote 408, their votes are counted 414, and a senate position is determined 420, based on the number of senate votes in favor of and opposed to the PL.

After consideration of the PL, the representatives vote 410, their votes are counted 416, and a representatives' position is determined 422, based on the number of elected representative votes in favor of and opposed to the PL.

After consideration of the PL, the registered direct voters vote 412, their votes are counted 418, and a direct voter position is determined 424, based on the number of direct votes in favor of and opposed to the PL.

There are numerous ways in which the three vote counts may be evaluated to determine whether the PL is to be accepted, block 426. These may be considered as:

(a) first methods to determine if the respective position 420, 422, and 424 of each of the three legislative units 402, 404 and 406 is considered to be in favor of accepting the PL; and

(b) second methods to determine if, based on (a), the position of the entire legislative body (i.e. the legislative body “as a whole”) is considered to be in favor of accepting the PL.

First methods involve setting either a numerical value of votes in favor of the PL, and setting a minimum percentage (e.g. 50, 60, 66⅔, 75), or both. The value for any one of the three entities 402, 404 and 406 need not be the same as that of any other of the three entities.

Second methods involve combining the results of the three positions 420, 422 and 424. Examples include:

(a) final acceptance requires that each of the three entities accept the PL;

(b) final acceptance requires that any two out of the three entities accept the PL;

(c) final acceptance requires that any one out of the three entities accept the PL;

(d) final acceptance requires acceptance by 402 and at least one of the other two entities;

(e) final acceptance requires acceptance by 404 and at least one of the other two entities;

(f) final acceptance requires acceptance by 406 and at least one of the other two entities; and

(g) final acceptance requires acceptance by at least one of

(i) 406, and (ii) both 402 and 404.

In a preferred embodiment of the invention, a time limit may be set (a) for the voting response of the DVs, and/or (b) for the voting response of the other two entities.

In still other preferred embodiment of the invention, once it is determined, block 426, that the PL is accepted (if such is the case), the President, i.e. the leader of the executive branch may exercise a veto, or other type of disapproval, of the PL—i.e. he may refuse to sign said PL into law. In one embodiment, said refusal is considered to be the final word, i.e. the PL is considered to be defeated. Other embodiments allow for an override of said Presidential veto, if a super-majority—e.g. a ⅔ majority—is achieved in one or more of the three voting entities, in particular:

(a) veto override requires that each of the three entities override the veto;

(b) veto override requires that any two out of the three entities override the veto;

(c) veto override requires that any one out of the three entities override the veto;

(d) veto override requires acceptance by 402 and at least one of the other two entities;

(e) veto override acceptance by 404 and at least one of the other two entities;

(f) veto override requires acceptance by 406 and at least one of the other two entities; and

(g) veto override requires acceptance by at least one of

(h) 406, and (ii) both 402 and 404.

In one embodiment of the invention, it is possible that two or more of the three entities may accept a different version of the PL, resulting in the need for negotiation over language in a final consensus version of the legislation. It is also possible that such consensus may need to be reached either before the legislation is proposed, or after a preliminary version of it has been proposed. It is furthermore possible that direct voters may wish to propose legislation themselves, or to propose parts of legislation. Each of two preferred embodiments of the invention would allow for direct voter participation in the aforementioned tasks.

In one such embodiment, the participation is accomplished by having the direct voters select a designated person, or “dPER,” who, once selected, is empowered to accomplish the aforesaid tasks on behalf of the direct voters. In contrast to a member of the house of representatives, said dPER might have a limited task and limited time during which he is empowered to act. The selection of the dPER would be accomplished by direct voting. The winning dPER or dPOS could be selected based on receiving a majority of the vote or based on having received the largest number of votes, compared to the other candidates.

In another embodiment, the DVs select a designated position, “dPOS.” The position may be as simple as a yes/no decision about particular clause in a particular piece of legislation, or may represent a much more substantial position, such as an entire piece of legislation.

Whether the DVs are selecting a dPER or dPOS, the DVs may have to select from among three or more nominees. If so, it is possible that the need for a runoff election will obtain (e.g. if no dPER of dPOS receives a majority of the vote). If so, one or more of such runoff elections may be necessary, each with a successively smaller number of candidates in the field.

In an alternative embodiment, the direct voters may vote using a weighting system in which each DV selects a plurality of choices for dPER or for dPOS, and in which a largest number of votes is assigned to the DV's first choice, a smaller number of votes to the DV's second choice, a still smaller number of votes to the DV's third choice, etc. Such a system may lessen the number of runoff elections or may decrease the number of runoff elections to 0. Such a system may result in a different selection for the final choice of dPER or dPOS, compared to the system in which DVs can only vote for one non-weighted candidate at the time of a voting procedure.

The following discussion addresses direct voter inventions in which the direct voters form a complete branch or part of a branch of government.

Direct Voting Legislature, One Unit

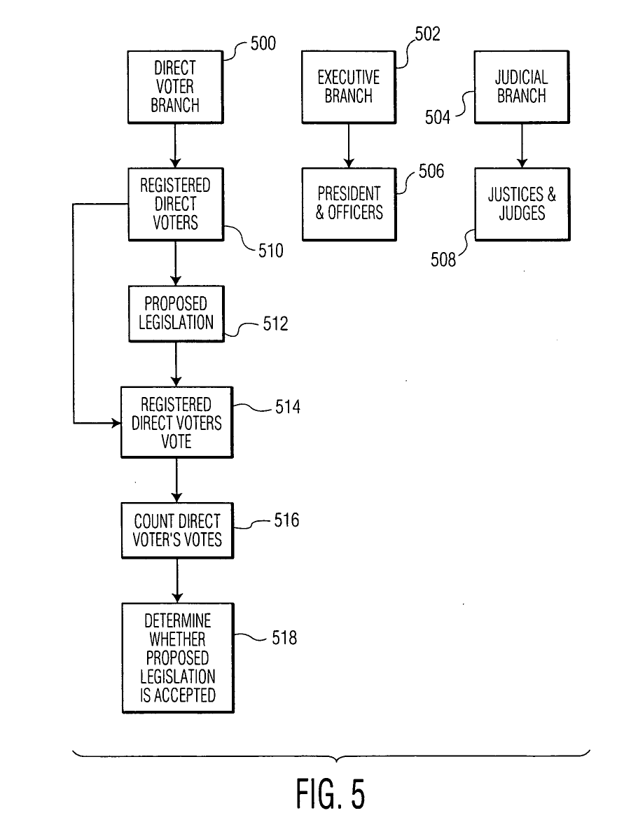

FIG. 5 shows an example of such an arrangement.

In a system of government whose structure is similar or equivalent to that of the U.S., i.e. including an executive branch 502 with a president and other officers 506, a judicial branch 504 with justices and judges 508, this embodiment has a legislative branch 500 characterized by direct voter participation only (“DV branch”).

In preferred embodiments of the invention, the direct voters vote using one or more of (a) the methods of voter registration 510 described hereinabove, (b) the methods of vote data transmission described hereinabove, and (c) the methods of vote confirmation described hereinabove.

The legislature in this embodiment is characterized by a single unit, responsive to the direct voters. The voters may vote on legislation that is proposed by:

a) direct voters, in a manner similar to the that described in conjunction with the aforementioned three branch legislature, using the aforementioned techniques involving dPERs and/or dPOSs; and/or

b) the executive branch.

PL 512 is voted on by registered direct voters 514. The vote is counted 516. Acceptance of legislation 518 may require a vote total in favor of acceptance that exceeds (a) a certain number; (b) a certain fraction of the number of residents of the jurisdiction; (c) a certain fraction of the number of registered direct voters; and (d) a certain fraction of the number of registered direct voters who vote in the determination of the acceptance of the PL in question (e.g. a simple majority or a ⅔ majority).

In a preferred embodiment of the invention, a presidential veto may occur, regarding PL which was accepted by the DVs. In one version of this preferred embodiment, the DVs may override the veto by a second DV voting event, in which a larger DV vote count or fraction is required than was required for the initial DV acceptance of the PL. In another version, if the required larger DV vote count or fraction was achieved during the initial DV vote, the president may not veto the accepted PL.

The U.S. Constitution allows for impeachment and an impeachment trial of a president and other government officials under certain circumstances; the constitutional procedure assigns different tasks to the U.S. House of Representatives and the U.S. Senate. In a preferred embodiment of this invention, these tasks, or tasks that parallel the constitutional ones may be:

(a) handled exclusively by the DV branch; or

(b) handled by a combination of the DV branch and the highest court of the jurisdiction.

In the former case, the impeachment vote takes place during a first voting procedure of the DV branch. The vote to convict then takes place during a second voting procedure of the DV branch (with requirement for voting number or fraction among the choices hereinabove).

In the latter case the impeachment is handled by the DV branch (with requirement for voting number or fraction among the choices hereinabove); and the trial is handled by the highest court.

Direct Voting Legislature, Two Units

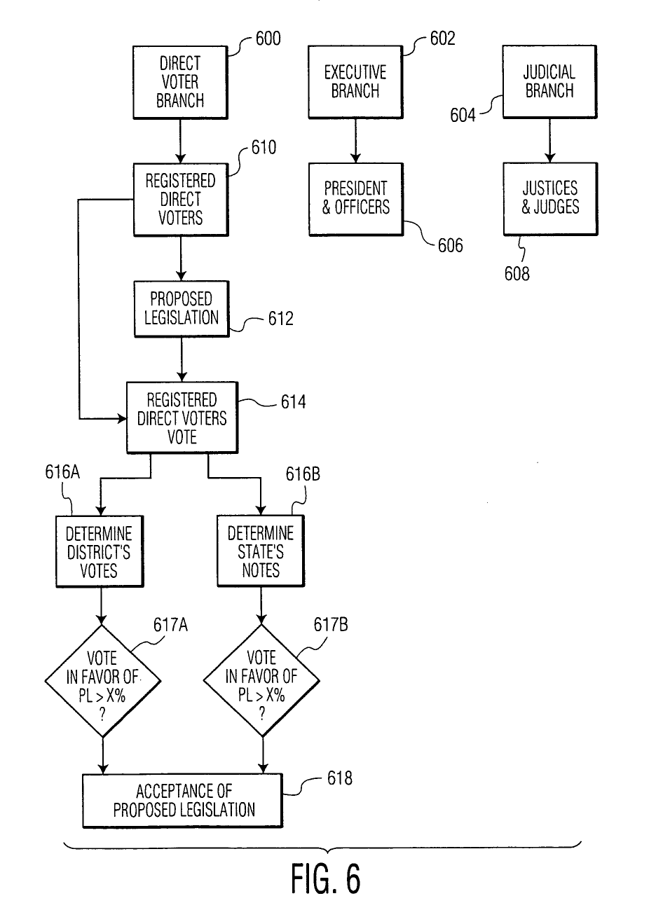

FIG. 6 shows an example of such an arrangement.

In a system of government whose structure is similar or equivalent to that of the U.S., i.e. including an executive branch 602 with a president and other officers 606, a judicial branch 604 with justices and judges 608, this embodiment has a legislative branch 600 characterized by direct voter participation only (“DV branch”).

In preferred embodiments of the invention, the direct voters vote using one or more of (a) the methods of voter registration 610 described hereinabove, (b) the methods of vote data transmission described hereinabove, and (c) the methods of vote confirmation described hereinabove.

The legislature in this embodiment is characterized by two units, each unit responsive to the direct voters. The first unit of the DV branch of this invention represents individuals in the jurisdiction based on a first consideration (e.g. one or more representatives for a given geographic area, [FIG. 6 shows an example where the first unit represents states within the U.S.]) and the second unit represents individuals in the jurisdiction based on a second consideration (e.g. one representative for a given number of residents, where residents are defined in conformity with the laws of the jurisdiction, [FIG. 6 shows an example where the first unit represents Congressional Districts in the U.S.]). Thus each resident is represented by each of the two units.

The voters may vote on legislation that is proposed by:

a) direct voters, in a manner similar to the that described in conjunction with the aforementioned three branch legislature, using the aforementioned techniques involving dPERs and/or dPOSs; and/or

b) the executive branch.

PL 612 is voted on by registered direct voters 614. The district vote is counted 616A. The state vote is counted 616B. Since each voter is part of both a district and a state, a single vote of the DV is sufficient for producing both counts.

There are numerous ways in which the two vote counts may be evaluated to determine whether the PL is to be accepted, block 618. These may be considered as:

(a) first methods to determine if the respective position of each of the two legislative units is considered to be in favor of accepting the PL; and

(b) second methods to determine if, based on (a), the position of the entire legislative body (i.e. the legislative body “as a whole”) is considered to be in favor of accepting the PL.

First methods involve setting either a numerical value of votes in favor of the PL, or setting a minimum percentage (X %, elements 617A and 617B. where X may be, for example, 50, 60, 66⅔, 75), or both. The value(s) for the first unit may not be the same as the value(s) for the second unit.

Second methods involve combining the results of the two units to determine acceptance 618 of the PL by the DV branch in this embodiment of the invention. Examples include (a) the requirement for X % of DV votes in both units; and (b) the requirement for X % of DV votes in either unit.

In a preferred embodiment of the invention, a presidential veto may occur, regarding PL which was accepted by the DVs. In one version of this preferred embodiment, the DVs may override the veto by a second DV voting event, in which a larger DV vote count or fraction (e.g. ⅔, ⅗, ¾, ⅘) is required than was required for the initial DV acceptance of the PL, and where the larger required fraction must be obtained when the count is done for each of the two units. In another version, if the required larger DV vote count or fraction was achieved during the initial DV vote, the president may not veto the accepted PL.

Impeachment of a President or other officer may be carried out, in the preferred embodiment of this invention, in a manner analogous to that prescribed by the U.S. Constitution.

An embodiment of the invention is possible in which the DV branch described herein may reverse the decision of a president.

Direct Voter Branch (“DVB-4”) as a Fourth Branch of the Government

This approach has features of both the aforementioned embodiment in which the DV branch is a 3^{rd} part of the legislature and the aforementioned embodiment in which there is a one-unit legislature consisting only of DVs. One advantage of this embodiment of the invention is that it allows for the richest network of checks and balances. Another advantage is that it could be gradually introduced/phased into the government of the United States with the least change in existing structures and functions at the outset.

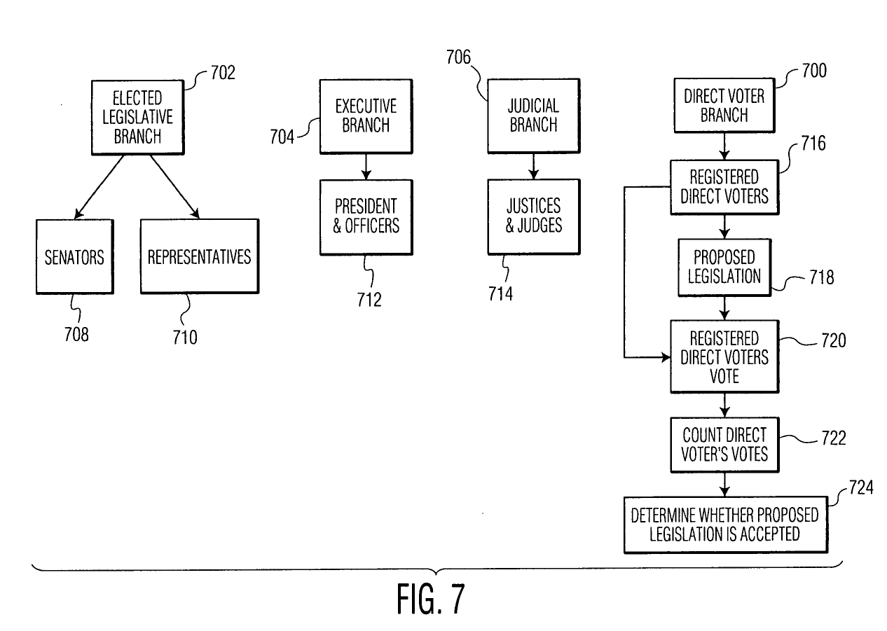

FIG. 7 shows an example of such an arrangement.

In a system of government whose structure is similar or equivalent to that of the U.S., i.e. including an executive branch 704 with a president and other officers 712, a judicial branch 706 with justices and judges 714, this embodiment has two legislative branches:

(a) a direct legislative branch 700 characterized by direct voter participation only (“DV branch”); and

(b) an elected legislative branch 702 with senators 708 whose functions and duties may be substantially similar to (or may have one or more significant differences compared to) those of U.S. Senators in 2006, and with representatives 710 whose functions and duties may be substantially similar to (or may have one or more significant differences compared to) those of members of the U.S. House of Representatives in 2006. Hereinbelow, for the sake of simplicity, 708 and 710 will be referred to as the “house” and the “senate.”

In preferred embodiments of the invention, the direct voters vote using one or more of (a) the methods of voter registration 716 described hereinabove, (b) the methods of vote data transmission described hereinabove, and (c) the methods of vote confirmation described hereinabove.

The direct legislative branch in this embodiment is characterized by a single unit, responsive to the direct voters. The direct voters may vote on legislation that is proposed by:

(a) direct voters, in a manner similar to the that described in conjunction with the aforementioned three branch legislature, using the aforementioned techniques involving dPERs and/or dPOSs;

(b) the executive branch; and/or

(c) the elected legislative branch.

PL 718 is voted on by registered direct voters 720. The vote is counted 722. Acceptance of legislation 724 by the direct voter branch may require a vote total in favor of acceptance that exceeds (a) a certain number; (b) a certain fraction of the number of residents of the jurisdiction; (c) a certain fraction of the number of registered direct voters; or (d) a certain fraction of the number of registered direct voters who vote in the determination of the acceptance of the PL in question (e.g. a simple majority or a ⅔ majority).

In one embodiment of the invention, the direct voter branch, DVB-4 may veto legislation or non-legislative decisions of (a) the house, (b) the senate, and (c) decisions requiring both house and senate approval. The DVB-4 veto may require either majority approval by the DVs, or a super-majority (e.g. ⅔), and there may be a requirement for a minimum number of DVs voting. The majority may be (a) of all residents of the jurisdiction, (b) of all registered direct voters, or (c) of all direct voters who vote for the issue under consideration. In another embodiment of the invention, DVB-4 may overrule the President on certain executive decisions; specified voting number minima and majority or super-majority requirements may be part of the overrule of an executive decision.

In a preferred embodiment of the invention, a presidential veto may occur, regarding PL which was accepted by the DVs. In one version of this preferred embodiment, the DVs may override the veto by a second DV voting event, in which a larger DV vote count or fraction is required than was required for the initial DV acceptance of the PL. In another version, if the required larger DV vote count or fraction was achieved during the initial DV vote, the president may not veto the accepted PL.

A variety of situations may occur in which the network of checks and balances regarding legislation spans three branches of this government. These situations include:

(a) DVB-4 vetoes legislation passed by the elected legislative branch, and the President reverses the DVB-4 veto;

(b) the President vetoes legislation passed by the elected legislative branch and DVB-4 overrules the President;

(c) the President vetoes legislation passed by the DVB-4 and the elected legislative branch overrules the President;

(d) the elected legislative branch vetoes legislation passed by DVB-4 and the President overrules the elected legislative branch;

(e) any one of (i) the vote of the representatives (ii) the vote of the senate, and (iii) the President, may overrule DVB-4;

(f) any two of (i) the vote of the representatives, (ii) the vote of the senate, and (iii) the President, may overrule DVB-4; and

(g) all three of (i) the vote of the representatives, (ii) the vote of the senate, and (iii) the President, together, may overrule DVB-4.

In certain actions concerning activities which are traditionally the domain of the U.S. House of Representatives, (e.g. proposed tax legislation) the DVB-4 may act in a parallel manner, such that approval of the PL requires either (a) approval of either the house or DVB-4, or (b) the approval of both the house and DVB-4.

In certain actions concerning activities which are traditionally the domain of the U.S. Senate, (e.g. treaty ratification) the DVB-4 may act in a parallel manner, such that approval of the PL requires either (a) approval of either the senate or DVB-4, or (b) the approval of both the senate and DVB-4.

In certain actions concerning activities which are traditionally within a domain requiring the joint action of both the U.S. House of Representatives, and the U.S. Senate (e.g. proposing a constitutional amendment) the DVB-4 may act in a parallel manner, such that approval of the PL requires either

(a) approval of at least one of (i) both the house and the senate or (ii) DVB-4;

(b) approval of all three of the house, the senate and DVB-4;

(c) both of (i) the senate and (ii) at least one of DVB-4 and the house.

In certain actions concerning activities which are traditionally the domain of the President of the U.S., (e.g. proposal of a Supreme Court nominee) the DVB-4 may act in a parallel manner, such that approval of the executive action requires (a) approval of DVB-4, and/or (b) approval of the president.

Verification Means

Various means are known in the art for verifying the identity of a direct voter, thereby assuring that each voter, for example a citizen who has been duly registered to vote, is entitled to one vote, and one vote only, per issue or legislation to be decided. Such means include one or more of the following:

A) fingerprint identification

B) DNA sample identification

C) Iris/retinal pattern identification

D) face identification

E) voiceprint identification

F) handwritten signature identification

G) digital signature identification

Appendix

Calculations for Direct Voters “Replacing” Part of a Representative

For this calculation, it is assumed that there are only two possible positions to take with respect to a particular piece of legislation; i.e. “yes” and “no.”

1) Let the number of votes in a district be referred to as P;

2) Let the number of direct voters who choose to vote in a particular session (i.e. for a particular piece of legislation) be referred to as Q; and

3) Let the number of direct voters whose voting position differs from the elected representative (to be referred to as the “representative,” but who could also be referred to as the “proxy representative” since he controls the votes of all of the people who do not directly vote) be referred to as R; then:

(a) The representative represents P−Q votes,

(b) The number of direct voters who agree with the position of the representative is Q−R, and

(c) The number of votes in favor of the representatives position is the sum of (a)+(b), that is,
(P−Q)+(Q−R)=P−R.

(d) To defeat the representative and those direct voters who support his position, R (the number of voters not supporting the representative) must exceed P−R (the number of voters supporting the representative), i.e.:
R>(P−R)

(e) By adding the quantity R to each side of the equation in (d), one obtains:
2R>P

(f) By dividing each side of the equation in (e) by 2, one obtains:
R>P/2

The statement in (f) allows us to substantially simplify language, and the discussion in general. It states that, given the aforementioned underlying assumptions:
if more than half of the residents vote directly in favor of an issue, they will “win”, regardless of the position of the representative; and
in every other scenario, the representative (or the representative's position) “wins.”
   Based on the above calculation, the people can veto the vote of the elected representative by a greater than 50% (direct) vote to do so. This, therefore, raises the possibility of an alternate system where the representative simply votes for all legislation, and where the people have the option of overriding the representative by providing a >50% direct vote override within some particular time interval—e.g. 24 or 48 hours after the REP's initial vote. This approach makes the voting process less cumbersome in some ways; i.e. it is the known, standard voting system unless the people decide to override the representative.

There has thus been shown and described novel government systems, in which individuals vote directly and in which representatives are partially or completely replaced, which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method of legislating for a legal jurisdiction, wherein a plurality of voting districts have been established within the jurisdiction, each district having a plurality of residents residing within the respective district, and each district may cast one district vote for the purpose of determining legislative decisions; wherein a representative from each district is selected who is entitled to vote on legislation on behalf of a plurality of the residents in that representative's respective district; and wherein eligible voters who have been registered within each district are entitled to vote; said method comprising the steps of:
(a) proposing legislation which, if enacted, is to be effective in the entire jurisdiction;
(b) casting representative's votes in favor of, or against the proposed legislation by each of a plurality of said representatives;
(c) casting registered voter votes in favor of, or against the proposed legislation by each of a plurality of registered voters in at least one district;
(d) counting the registered voter votes in said at least one district to determine the number of registered voter votes in favor of, and the number of such votes against the proposed legislation in that district;
(e) counting the district vote as in favor of the same choice as that supported by the representative's vote in a given district, unless the number of registered voters in the given district voting differently than did the representative of that district exceeds a given number for that district, in which case the district vote shall be deemed to be in favor of the choice opposite that supported by the representative's vote; and
(f) determining whether the proposed legislation is to be accepted in dependence upon whether the number of district votes counted in favor of the proposed legislation, multiplied by one hundred, divided by the total number of district votes counted is greater than a prescribed percentage.

2. The method defined in claim 1, wherein the given number is equal to half the number of residents in the district.

3. The method defined in claim 1, wherein the given number is selected from the group consisting of (i) half the number of registered voters in the district, and (ii) half the number of registered voters in the district who cast votes regarding said proposed legislation.

4. The method defined in claim 1, wherein, if the representative of any district does not cast a vote either in favor of, or against the legislation, the vote for that district is determined by a majority of the votes cast by the registered voters of that district, provided that the total number of votes cast by the registered voters in that district is at least a prescribed minimum.

5. The method defined in claim 1, wherein the prescribed percentage is selected from the group consisting of (a) fifty percent, (b) sixty percent, (c) sixty-six and two thirds percent and (d) seventy five percent.

6. The method defined in claim 4, wherein the prescribed minimum is one.

7. The method defined in claim 4, wherein the prescribed minimum is selected from the group consisting of (a) one half of the total number of registered voters in the respective district and (b) one half the total number of residents in the respective district.

8. The method defined in claim 1, wherein the registered voters cast registered voter votes using electronic communication by means of a device selected from the group consisting of (a) a computer linked to the internet, (b) a public telephone device, (c) a computer linked to a dedicated network, and (d) a private communication device.

9. A method of legislating for a legal jurisdiction, wherein a plurality of voting districts have been established within the jurisdiction, each district having a plurality of residents residing within the respective district, and each district may cast one district vote for the purpose of determining legislative decisions; wherein a representative from each district is selected who is entitled to vote on legislation on behalf of the residents in that representative's respective district; and wherein eligible voters who have been registered within each district are entitled to vote;
said method comprising the steps of:
(a) proposing legislation which, if enacted, is to be effective in the entire jurisdiction;
(b) each of a plurality of said representatives casting a representative's vote in favor of, or against the proposed legislation, to reflect the position of each said representative;
(c) casting registered voter votes in favor of, or against the proposed legislation by each of a plurality of registered voters in a district;
(d) counting the registered voter votes in each district in which registered voter votes are cast to determine the number of votes in favor of, and the number of votes against the proposed legislation in that district;
(e) determining the number of oppositional registered voter votes as those registered voter votes which are in opposition to the position represented by said representative in a given district;
(f) determining the anti-representative fraction of the district vote as the number of oppositional registered voter votes divided by the number of residents in the given district;
(g) determining the pro-representative fraction of the district vote as the fraction whose numerator is (i) the number of residents in the given district minus (ii) the number of oppositional registered voter votes and whose denominator is the number of residents in the given district;
(h) counting the fraction of the district vote in favor of the legislation in the given district as (i) the pro-representative fraction of the district vote, if said district representative voted in favor of said legislation and as (ii) the anti-representative fraction of the district vote, if said district representative voted against said legislation; and
(i) counting the fraction of the district vote against the legislation in the given district as (i) the pro-representative fraction of the district vote, if said district representative voted against said legislation and as (ii) the anti-representative fraction of the district vote, if said district representative voted in favor of said legislation;
(j) determining whether the proposed legislation is to be accepted in dependence upon whether the sum of the fractional district votes in favor of the legislation multiplied by one hundred exceeds a prescribed percentage of the total number of district votes.

10. The method defined in claim 9, wherein the prescribed percentage is selected from the group consisting of (i) fifty percent and (ii) sixty-six and two thirds percent.

11. The method defined in claim 9, wherein, if the representative of any district does not cast a vote either in favor of, or against the legislation, the vote for that district is determined by the votes cast by the registered voters of that district, wherein the fractional district vote in favor of the legislation is determined to be the fraction whose numerator is the number of registered voter votes in favor of said legislation in said district, and whose denominator is the total number of registered voter votes cast regarding said legislation in said district.

12. The method defined in claim 9, wherein, if the representative of any district does not cast a vote either in favor of, or against the legislation, the vote for that district is determined by the votes cast by the registered voters of that district, and wherein:
(i) the fractional district vote in favor of the legislation is determined to be the fraction whose numerator is the number of registered voter votes in said district in favor of said legislation, and whose denominator is the total number of residents in said district;
(ii) the fractional district vote against the legislation is determined to be the fraction whose numerator is the number of registered voter votes in said district against said legislation, and whose denominator is the total number of residents in said district; and
(iii) said total number of district votes in (j) is the sum of (a) the sum of all fractional district votes in favor of the legislation; and
(b) the sum of all the fractional district votes against the legislation.

13. The method defined in claim 9, wherein the registered voters cast registered voter votes using electronic communication by means of a device selected from the group consisting of (a) a computer linked to the internet, (b) a public telephone device, (c) a computer linked to a dedicated network, and (d) a private communication device.

14. A method of legislating for a legal jurisdiction, wherein a plurality of states have been established within the jurisdiction, wherein at least one voting district has been established within each state, each state and each district having a plurality of residents residing within the respective state and district, wherein two senators are selected for each state who are entitled to vote on legislation on behalf of the residents in each senator's respective state; wherein a representative is selected for each district who is entitled to vote on legislation on behalf of the residents in that representative's respective district; and wherein eligible voters have been registered to vote within each district in each state; said method comprising the steps of:
(a) proposing legislation which, if enacted, is to be effective in the entire jurisdiction;
(b) casting senator's votes in favor of, or against the proposed legislation by each of a plurality of said senators representing their respective states;
(c) casting representative's votes in favor of, or against the proposed legislation by each of a plurality of said representatives representing their respective districts;
(d) casting registered voter votes in favor of, or against the proposed legislation by each of a plurality of registered voters;
(e) counting the senator's votes to determine a final senate majority vote in favor of, or against the legislation;
(f) counting the representative's votes to determine a final representative majority vote in favor of, or against the legislation;
(g) counting the registered voter votes, if any, to determine the number of registered voter votes in favor of, and the number of registered voter votes against the proposed legislation, thereby to determine a final registered voter majority vote in favor of, or against the legislation; and
(i) determining whether the proposed legislation is to be accepted in dependence upon the final senate majority vote, the final representative majority vote and the final registered voter majority vote in favor of, or against the legislation.

15. The method defined in claim 14, wherein said majority vote is selected from the group consisting of (a) a simple majority vote, (b) a three fifths majority vote, (c) a two thirds majority vote and (d) a three quarters majority vote.

16. The method defined in claim 15, wherein the majority vote required for acceptance of the proposed legislation by at least one of the final senate majority vote, the final representative majority vote and the final registered voter majority vote is different than the majority vote required for acceptance of the proposed legislation by another one thereof.

17. The method defined in claim 14, wherein the registered voters cast registered voter votes using electronic communication by means of a device selected from the group consisting of (a) a computer linked to the internet, (b) a public telephone device, (c) a computer linked to a dedicated network, and (d) a private communication device.

18. The method defined in claim 14, wherein passage of legislation requires a final senate majority vote, a final representative majority vote and a final registered voter majority vote, all in favor of the legislation.

19. The method defined in claim 14, wherein passage of legislation requires at least two of (a) a final senate majority vote, (b) a final representative majority vote and (c) a final registered voter majority vote in favor of the legislation.

20. The method defined in claim 14, wherein passage of legislation requires a final representative majority vote in favor of the legislation and at least one of a final senate majority vote and a final registered voter majority vote in favor of the legislation.

21. The method defined in claim 14, wherein passage of legislation requires (a) a final senate majority vote in favor of the legislation and (b) at least one of (i) a final representative majority vote and (ii) a final registered voter majority vote in favor of the legislation.

22. The method defined in claim 14, wherein passage of legislation requires a final registered voter majority vote in favor of the legislation and at least one of a final senate majority vote and a final representative majority vote in favor of the legislation.

23. The method defined in claim 14, wherein passage of legislation requires at least one of (a) a final registered voter majority vote in favor of the legislation (b) a final senate majority vote in favor of the legislation and (c) a final representative majority vote in favor of the legislation.

24. The method defined in claim 14, wherein passage of legislation requires at least one of (a) a final registered voter majority vote in favor of the legislation and (b) a final senate majority vote and a final representative majority vote in favor of the legislation.

25. The method defined in claim 14, wherein a minimum number of registered voter votes is required in order for such votes to be valid, said minimum number being selected from the group consisting of (i) an absolute number and (ii) a percentage of the total number of registered voters.

26. The method of claim 14, wherein said minimum number of registered voter votes must be cast within a prescribed interval of time after voting begins.

27. The method of claim 25, wherein, in the absence of said minimum number of valid registered voter votes, the passage of the proposed legislation is determined by the final senate vote and the final representative vote.

28. The method of claim 14, wherein said determining step (i) to accept said proposed legislation may be vetoed by a President.

29. The method defined in claim 28, wherein a veto by said President may be overridden by a ⅔ majority vote by each of said final senate vote, said final representative vote and said final registered voter vote.

30. The method defined in claim 28, wherein a veto by said President may be overridden by a ⅔ majority vote by at least two of (a) said final senate vote, (b) said final representative vote and (c) said final registered voter vote.

31. The method defined in claim 28, wherein a veto by said President may be overridden by a ⅔ majority vote by (a) said final representative vote and (b) at least one of said final senate vote and said final registered voter vote.

32. The method defined in claim 28, wherein a veto by said President may be overridden by a ⅔ majority vote by (a) said final senate vote and (b) at least one of said final representative vote and said final registered voter vote.

33. The method defined in claim 28, wherein a veto by said President may be overridden by a ⅔ majority vote by (a) said final registered voter vote and (b) at least one of said final senate vote and said final representative vote.

34. The method defined in claim 28, wherein a veto by said President may be overridden by a ⅔ majority vote by at least one of (a) said final registered voter vote (b) said final senate vote and (c) said final representative vote.

35. The method defined in claim 28, wherein a veto by said President may be overridden by a ⅔ majority vote by at least one of (a) said final registered voter vote and (b) each of said final senate vote and said final representative vote.

36. The method of claim 14, wherein said registered voters select at least one designated person by a registered voter vote, and wherein said designated person is empowered to perform at least one task selected from the group consisting of (a) drafting language of proposed legislation and (b) negotiating changes in language of proposed legislation.

37. The method of claim 36, wherein said designated person is selected from a plurality of nominees who are nominated by said registered voters by the steps of:
(a) casting and counting registered voter votes in favor of, or against a nominee;
(b) selecting the designated person in dependence upon the number of registered voter votes in favor of such nominee.

38. The method of claim 37, wherein said designated person is the recipient of the number of votes selected from the group consisting of (a) the largest number of registered voter votes among all the nominees, and (b) a majority of registered voter votes cast.

39. The method of claim 37, wherein two or more preliminary designated persons are selected as those who receive the largest numbers of registered voter votes in a first election, and wherein said designated person is selected as the person who receives the largest number of registered voter votes during a second election in which the candidates are said preliminary designated persons.

40. The method of claim 37, wherein n−1 groups of two or more designated person nominees are selected as those who receive the largest numbers of registered voter votes in each of n−1 intermediate voting procedures, where n is an integer, where such intermediate voting procedures are repeatedly held, each with a successively smaller number of designated person nominees, each of such successively smaller number of designated person nominees having received the largest numbers of votes in the previous voting procedure, and wherein one final designated person is selected as the person who receives the largest number of votes during a final, nth voting procedure in which the candidates are the designated person nominees selected by the last intermediate voting procedure.

41. The method of claim 36, wherein said designated person is empowered to negotiate with at least one of (a) at least one senator and (b) at least one representative, to agree upon language of proposed legislation.

42. The method of claim 14, wherein said registered voters select at least one designated position by a registered voter vote, and wherein said designated position is selected from the group consisting of:
(a) draft language of proposed legislation;
(b) changes in language of proposed legislation forming compromise language for legislation which has already been voted on;
(c) a yes/no decision relating to a legislative proposal;
(d) a yes/no decision relating to the inclusion of at least one section within a legislative proposal;
(e) a numerical value relating to a quantity within a legislative proposal; and
(f) a number which corresponds to the numerical identifier of one of a plurality of possible legislative proposals.

43. The method of claim 42, wherein said designated position is selected from a plurality of nominated positions which are nominated by said registered voters and selected by the steps of:
(a) casting and counting registered voter votes in favor of, or against a nominated position;
(b) selecting the designated position in dependence upon the number of registered voter votes in favor of such nominated position.

44. The method of claim 43, wherein said designated position is the recipient of the number of votes selected from the group consisting of (a) the largest number of registered voter votes among all the nominated positions, and (b) a majority of registered voter votes cast.

45. The method of claim 43, wherein two or more preliminary designated positions are selected as those which receive the largest numbers of registered voter votes in a first election, and wherein said designated position is selected as the position which receives the largest number of registered voter votes during a second election in which the candidates are said preliminary designated positions.

46. The method of claim 43, wherein n−1 groups of two or more first designated positions are selected as those which receive the largest numbers of registered voter votes in each of n−1 intermediate voting procedures, where n is an integer, where such intermediate voting procedures are repeatedly held, each with a successively smaller number of designated position nominees, each of such successively smaller number of designated position nominees having received the largest numbers of votes in the previous voting procedure, and wherein one final designated position is selected as the designated position which receives the largest number of votes during a final, nth voting procedure, in which the candidates are the nth designated positions selected by the last intermediate voting procedure.

47. The method of claim 42, wherein said designated position is the position of the registered voters in a negotiation with at least one of (a) at least one senator and (b) at least one representative, to agree upon language of proposed legislation.

48. A method of government for a legal jurisdiction, wherein a direct voting legislative branch has been established whose powers include voting on proposed legislation to ensure that the will of the people is known and acted upon in a_substantially real-time basis, said legislative branch comprising eligible voters who have been registered to vote on legislation on behalf of the residents of the jurisdiction; wherein an executive branch has been established which comprises a plurality of officers including a President whose powers include the nomination of certain judges, the proposal of legislation and the disapproval of legislation; wherein a judicial branch has been established to interpret the laws of the jurisdiction, said judicial branch comprising a plurality of justices and judges; said method comprising the steps of:
(a) proposing an issue for decision by the legislative branch;
(b) casting registered voter votes in favor of, or against the proposed issue by each of a plurality of said registered voters;
(c) counting the registered voter votes to determine the number of votes in favor of, and the number of votes against the proposed issue; and
(d) determining whether the proposed issue is accepted by the legislative branch in dependence upon the counted registered voter votes in favor of, or against the issue.

49. The method defined in claim 48, wherein the proposed issue is accepted when the number of votes in favor of the proposed issue exceeds the number of votes against the proposed issue.

50. The method defined in claim 48, wherein the President has authority to approve or disapprove proposed legislation, and wherein legislation accepted by said legislative branch is disapproved by said President.

51. The method defined in claim 48, wherein said proposed issue is a reversal of a decision of the President to disapprove the legislation.

52. The method defined in claim 51, wherein, after legislation is accepted by the legislative branch and is disapproved by the President, said legislative branch may override the disapproval by a method comprising the steps of:
(a) casting second registered voter votes in favor of, or against overriding said disapproval by each of a second plurality of registered voters;
(b) counting said second registered voter votes to determine the number of second registered voter votes in favor of, and the number of second registered voter votes against overriding said disapproval; and
(c) determining whether the disapproval has been overridden by the legislative branch in dependence upon the number of second registered voter votes in favor of, or against said override.

53. The method defined in claim 52, wherein said disapproval override is accepted when the number of second votes in favor of overriding the disapproval, divided by the total number of second votes exceeds the fraction selected from the group consisting of: (i) three fifths, (ii) two thirds, (iii) three quarters, and (iv) four fifths.

54. The method defined in claim 48, wherein said judicial branch includes a Supreme Court, which constitutes the court of highest instance in an hierarchical structure; wherein said proposed issue is impeachment of the President; and wherein, if said issue is passed by said legislative branch, said Supreme Court makes the determination of the President's guilt or innocence in such impeachment.

55. The method defined in claim 48, wherein said proposed issue is impeachment of the President, and wherein, if said issue is accepted by said legislative branch, said legislative branch must vote a second time to determine whether or not said President is convicted, said second vote comprising the steps of:
(a) casting second registered voter votes in favor of, or against said conviction by each of a second plurality of registered voters;
(b) counting said second registered voter votes to determine the number of second registered voter votes in favor of, and the number of second registered voter votes against said conviction; and
(c) determining whether there has been a conviction by the legislative branch in dependence upon the counted second registered voter votes in favor of, or against said conviction.

56. The method defined in claim 55, wherein said conviction is said to occur when the number of second votes in favor of said conviction divided by the total number of second votes exceeds the fraction selected from the group consisting of: (i) three fifths, (ii) two thirds, (iii) three quarters, and (iv) four fifths.

57. The method defined in claim 48, wherein at least one of (i) a declaration of war, (ii) an authorization to borrow money, and (iii) the proposal of a constitutional amendment must be voted on and accepted by the legislative branch.

58. The method of claim 48, wherein said registered voters select at least one designated person by a registered voter vote, and wherein said designated person is empowered to perform at least one task selected from the group consisting of (a) drafting language of proposed legislation and (b) negotiating changes in language of proposed legislation.

59. The method of claim 58, wherein said designated person is selected from a plurality of nominees who are nominated by said registered voters by the steps of:
(c) casting and counting registered voter votes in favor of, or against a nominee;
(d) selecting the designated person in dependence upon the number of registered voter votes in favor of such nominee.

60. The method of claim 59, wherein said designated person is the recipient of the number of votes selected from the group consisting of (a) the largest number of registered voter votes among all the nominees, and (b) a majority of registered voter votes cast.

61. The method of claim 59, wherein two or more preliminary designated persons are selected as those who receive the largest numbers of registered voter votes in a first election, and wherein said designated person is selected as the person who receives the largest number of registered voter votes during a second election in which the candidates are said preliminary designated persons.

62. The method of claim 59, wherein n−1 groups of two or more designated person nominees are selected as those who receive the largest numbers of registered voter votes in each of n−1 intermediate voting procedures, where n is an integer, where such intermediate voting procedures are repeatedly held, each with a successively smaller number of designated person nominees, each of such successively smaller number of designated person nominees having received the largest numbers of votes in the previous voting procedure, and wherein one final designated person is selected as the person who receives the largest number of votes during a final, nth voting procedure in which the candidates are the designated person nominees selected by the last intermediate voting procedure.

63. The method of claim 48, wherein said registered voters select at least one designated position by a registered voter vote, and wherein said designated position is selected from the group consisting of:
(a) draft language of proposed legislation;
(b) changes in language of proposed legislation forming compromise language for legislation which has already been voted on;
(c) a yes/no decision relating to a legislative proposal;
(d) a yes/no decision relating to the inclusion of at least one section within a legislative proposal;
(e) a numerical value relating to a quantity within a legislative proposal; and
(f) a number which corresponds to the numerical identifier of one of a plurality of possible legislative proposals.

64. The method of claim 63, wherein said designated position is selected from a plurality of nominated positions which are nominated by said registered voters and selected by the steps of:
(a) casting and counting registered voter votes in favor of, or against a nominated position;
(b) selecting the designated position in dependence upon the number of registered voter votes in favor of such nominated position.

65. The method of claim 64, wherein said designated position is the recipient of the number of votes selected from the group consisting of (a) the largest number of registered voter votes among all the nominated positions, and (b) a majority of registered voter votes cast.

66. The method of claim 64, wherein two or more preliminary designated positions are selected as those which receive the largest numbers of registered voter votes in a first election, and wherein said designated position is selected as the position which receives the largest number of registered voter votes during a second election in which the candidates are said preliminary designated positions.

67. The method of claim 64, wherein n−1 groups of two or more first designated positions are selected as those which receive the largest numbers of registered voter votes in each of n−1 intermediate voting procedures, where n is an integer, where such intermediate voting procedures are repeatedly held, each with a successively smaller number of designated position nominees, each of such successively smaller number of designated position nominees having received the largest numbers of votes in the previous voting procedure, and wherein one final designated position is selected as the designated position which receives the largest number of votes during a final, nth voting procedure, in which the candidates are the nth designated positions selected by the last intermediate voting procedure.

68. The method defined in claim 48, wherein the registered voters cast registered voter votes using electronic communication by means of a device selected from the group consisting of (a) a computer linked to the internet, (b) a public telephone device, (c) a computer linked to a dedicated network, and (d) a private communication device.

69. A method of government for a legal jurisdiction, wherein a plurality of states have been established within the jurisdiction, wherein at least one voting district has been established within each state, each state and each district having a plurality of residents residing within the respective state and district; wherein a direct voting legislative branch has been established whose powers include voting on proposed legislation to ensure that the will of the people is known and acted upon in a substantially real-time basis, said legislative branch comprising eligible voters who have been registered to vote on legislation on behalf of the residents of the jurisdiction; said legislative branch comprising a first unit and a second unit, said first unit for determining a first voting position of the eligible voters who are entitled to vote on behalf of the residents of each respective state, said second unit for determining a second voting position of the eligible voters who are entitled to vote on behalf of the residents of each respective district; wherein an executive branch has been established which comprises a plurality of officers including a President whose powers include the nomination of certain judges, the proposal of legislation and the veto of legislation; wherein a judicial branch has been established to interpret the laws of the jurisdiction, said judicial branch comprising a plurality of justices and judges; said method comprising the steps of:
(a) proposing an issue for decision by the legislative branch;
(b) casting registered voter votes in favor of, or against the proposed issue by each of a plurality of registered voters;
(c) for each district, counting the respective district vote by counting the registered voter votes in the respective district to determine the number of votes in favor of, and the number of votes against the proposed issue;
(d) for each state, counting the respective state vote by counting the registered voter votes in the respective state to determine the number of votes in favor of, and the number of votes against the proposed issue; and
(e) determining whether the proposed legislation is to be accepted in dependence upon whether:
(1) the number of district votes counted in favor of the proposed legislation, multiplied by one hundred, divided by the total number of district votes counted is greater than a prescribed percentage; and
(2) the number of state votes counted in favor of the proposed legislation, multiplied by one hundred, divided by the total number of state votes counted is greater than a prescribed percentage.

70. The method defined in claim 69, wherein the prescribed percentage is selected from the group consisting of (i) fifty percent and (ii) sixty-six and two thirds percent.

71. The method defined in claim 69, wherein legislation approved by said legislative branch may be vetoed by said President.

72. The method defined in claim 69, wherein said proposed issue is a reversal of a decision of the President.

73. The method defined in claim 71, wherein after legislation is approved by the legislative branch and is vetoed by the President, said legislative branch may override said veto by a method comprising the steps of
(a) casting second registered voter votes in favor of, or against overriding said veto by each of a second plurality of registered voters;
(b) in each district, counting the respective second district vote by counting the second registered voter votes in the respective district to determine the number of votes in favor of, and the number of votes against the veto override;
(c) in each state, counting the respective second state vote by counting the second registered voter votes in the respective state to determine the number of votes in favor of, and the number of votes against the veto override; and
(d) determining whether the veto has been overridden by the legislative branch in dependence upon (1) the number of second district votes in favor of, or against said override; and (2) the number of second state votes in favor of, or against said override.

74. The method defined in claim 73, wherein said veto override is accepted when both (1) the number of second district votes in favor of overriding the veto, divided by the total number of second district votes, and (2) the number of second state votes in favor of overriding the veto, divided by the total number of second state votes, exceed the fraction selected from the group consisting of: (i) three fifths, (ii) two thirds, (iii) three quarters, and (iv) four fifths.

75. The method of claim 69, wherein said registered voters select at least one designated person by a registered voter vote, and wherein said designated person is empowered to perform at least one task selected from the group consisting of (a) drafting language of proposed legislation and (b) negotiating changes in language of proposed legislation.

76. The method of claim 75, wherein said designated person is selected from a plurality of nominees who are nominated by said registered voters by the steps of:
(e) casting and counting registered voter votes in favor of, or against a nominee;
(f) selecting the designated person in dependence upon the number of registered voter votes in favor of such nominee.

77. The method of claim 76, wherein said designated person is the recipient of the number of votes selected from the group consisting of (a) the largest number of registered voter votes among all the nominees, and (b) a majority of registered voter votes cast.

78. The method of claim 76, wherein two or more preliminary designated persons are selected as those who receive the largest numbers of registered voter votes in a first election, and wherein said designated person is selected as the person who receives the largest number of registered voter votes during a second election in which the candidates are said preliminary designated persons.

79. The method of claim 76, wherein n−1 groups of two or more designated person nominees are selected as those who receive the largest numbers of registered voter votes in each of n−1 intermediate voting procedures, where n is an integer, where such intermediate voting procedures are repeatedly held, each with a successively smaller number of designated person nominees, each of such successively smaller number of designated person nominees having received the largest numbers of votes in the previous voting procedure, and wherein one final designated person is selected as the person who receives the largest number of votes during a final, nth voting procedure in which the candidates are the designated person nominees selected by the last intermediate voting procedure.

80. The method of claim 69, wherein said registered voters select at least one designated position by a registered voter vote, and wherein said designated position is selected from the group consisting of:
(a) draft language of proposed legislation;
(b) changes in language of proposed legislation forming compromise language for legislation which has already been voted on;
(c) a yes/no decision relating to a legislative proposal;
(d) a yes/no decision relating to the inclusion of at least one section within a legislative proposal;
(e) a numerical value relating to a quantity within a legislative proposal; and
(f) a number which corresponds to the numerical identifier of one of a plurality of possible legislative proposals.

81. The method of claim 80, wherein said designated position is selected from a plurality of nominated positions which are nominated by said registered voters and selected by the steps of:
(a) casting and counting registered voter votes in favor of, or against a nominated position;
(b) selecting the designated position in dependence upon the number of registered voter votes in favor of such nominated position.

82. The method of claim 81, wherein said designated position is the recipient of the number of votes selected from the group consisting of (a) the largest number of registered voter votes among all the nominees, and (b) a majority of registered voter votes cast.

83. The method of claim 81, wherein two or more preliminary designated positions are selected as those which receive the largest numbers of registered voter votes in a first election, and wherein said designated position is selected as the position which receives the largest number of registered voter votes during a second election in which the candidates are said preliminary designated positions.

84. The method of claim 81, wherein n−1 groups of two or more first designated positions are selected as those which receive the largest numbers of registered voter votes in each of n−1 intermediate voting procedures, where n is an integer, where such intermediate voting procedures are repeatedly held, each with a successively smaller number of designated position nominees, each of such successively smaller number of designated position nominees having received the largest numbers of votes in the previous voting procedure, and wherein one final designated position is selected as the designated position which receives the largest number of votes during a final, nth voting procedure, in which the candidates are the nth designated positions selected by the last intermediate voting procedure.

85. The method defined in claim 69, wherein the registered voters cast registered voter votes using electronic communication by means of a device selected from the group consisting of (a) a computer linked to the internet, (b) a public telephone device, (c) a computer linked to a dedicated network, and (d) a private communication device.

86. A method of government for a legal jurisdiction, wherein a plurality of states have been established within the jurisdiction, wherein at least one voting district has been established within each state, each state and each district having a plurality of residents residing within the respective state and district; wherein an elected legislative branch has been established whose powers include voting on proposed legislation, said legislative branch comprising two senators selected for each state who are entitled to vote in a senate vote on legislation on behalf of the residents in each senator's respective state and a representative selected for each district who is entitled to vote in a representative vote on legislation on behalf of the residents in that representative's respective district; wherein an executive branch has been established to execute the laws of the jurisdiction among other powers and responsibilities, said executive branch comprising a plurality of officers including a President whose powers include the nomination of certain judges, the proposal of legislation and the veto of legislation accepted by the elected legislative branch, provided that a second senate vote and a second representative vote do not reverse said veto; wherein a judicial branch has been established to interpret the laws of the jurisdiction, said judicial branch comprising a plurality of justices and judges; and wherein a direct voter branch has been established to ensure that the will of the people is known and acted upon in a substantially real-time basis, said direct voter branch comprising eligible voters who have been registered to vote within each district and in each state;
said method comprising the steps of:
(a) proposing an issue for decision by the direct voter branch;
(b) casting registered voter votes in favor of, or against the proposed issue by each of a plurality of registered voters;
(c) counting the registered voter votes to determine the number of registered voter votes in favor of, and the number of registered voter votes against the proposed issue; and
(d) determining whether the proposed issue is accepted by the direct voter branch in dependence upon the counted registered voter vote in favor of, or against the issue.

87. The method defined in claim 86, wherein the proposed issue is accepted when the number of registered voter votes in favor of the proposed issue exceeds the number of registered voter votes against the proposed issue.

88. The method defined in claim 86, wherein said proposed issue (a) is a disapproval by the direct voter branch of at least one of (i) legislation, and (ii) a non-legislative decision, which was accepted by at least one of (i) said senate vote, and (ii) said representative vote.

89. The method defined in claim 88, wherein the proposed issue is accepted when the number of registered voter votes cast in favor of the proposed issue divided by the total registered voter votes cast in regard to the proposed issue exceeds the fraction selected from the group consisting of: (i) one half, and (ii) two thirds.

90. The method defined in claim 88, wherein said President is empowered to reverse the disapproval of said direct voter branch.

91. The method defined in claim 86, wherein said proposed issue is a reversal of a decision of the President.

92. The method defined in claim 91, wherein said decision of the President is a disapproval of legislation passed by said senate vote and said representative vote.

93. The method defined in claim 91, wherein at least one of (i) said representative vote, and (ii) said senate vote, if favorable, will reinstate said decision of the President after said reversal of said decision by said direct voter branch.

94. The method defined in claim 86, wherein at least one of (i) said representative vote, (ii) said senate vote, and (iii) a decision of the President, if favorable, will overrule a direct voter vote accepting a proposed issue.

95. The method defined in claim 86, wherein at least two of (i) said representative vote, (ii) said senate vote, and (iii) a decision of the President, if favorable, will overrule a direct voter vote accepting a proposed issue.

96. The method defined in claim 86, wherein all three of (i) said representative vote, (ii) said senate vote, and (iii) a decision of the President, if favorable, will overrule a direct voter vote accepting a proposed issue.

97. The method defined in claim 86, wherein a proposed issue selected from the group consisting of (i) an impeachment of the President and (ii) proposed tax legislation and (iii) any other matter which has been empowered for approval by the U.S. House of Representatives must be voted on and accepted by at least one of (i) a representative vote and (ii) a direct voter vote.

98. The method defined in claim 86, wherein at least one of (i) a trial for impeachment of the President, (ii) the confirmation hearing of a judge, (iii) a treaty ratification and (iv) any other matter which has been empowered for approval by the U.S. Senate must be voted on and accepted by at least one of (i) a senate vote and (ii) a direct voter vote.

99. The method defined in claim 86, wherein at least one of (i) the power to declare war, (ii) the power to borrow money, (iii) the power to propose a constitutional amendment and (iv) any other matter which has been empowered for approval by both the U.S. Senate and the U.S. House of Representatives must be voted on and accepted by at least one of (i) both the senate vote and representative vote, and (ii) the direct voter vote.

100. The method defined in claim 86, wherein at least one of (i) the power to declare war, (ii) the power to borrow money and (iii) the power to propose a constitutional amendment and (iv) any other matter which is empowered for approval by both the U.S. Senate and the U.S. House of Representatives must be voted on and accepted by all three of (i) the senate vote, (ii) the representative vote, and (iii) the direct voter vote.

101. The method defined in claim 86, wherein at least one of (i) the power to declare war, (ii) the power to borrow money, (iii) the power to propose a constitutional amendment and (iv) any other matter which is empowered for approval by both the U.S. Senate and the U.S. House of Representatives must be voted on and accepted by (i) the senate vote, and (ii) at least one of the representative vote and the direct voter vote.

102. The method defined in claim 86, wherein said proposed issue (a) is at least one of (i) the proposal of at least one Supreme Court nominee, (ii) the granting of a reprieve, (iii) the granting of a pardon, and (iv) any other power which is given to the President of the U.S. must be voted on and accepted by at least one of (i) the President, and (ii) a direct voter vote.

103. The method of claim 86, wherein said registered voters select at least one designated person by a registered voter vote, and wherein said designated person is empowered to perform at least one task selected from the group consisting of (a) drafting language of proposed legislation and (b) negotiating changes in language of proposed legislation.

104. The method of claim 103, wherein said designated person is selected from a plurality of nominees who are nominated by said registered voters by the steps of:
(g) casting and counting registered voter votes in favor of, or against a nominee;
(h) selecting the designated person in dependence upon the number of registered voter votes in favor of such nominee.

105. The method of claim 104, wherein said designated person is the recipient of the number of votes selected from the group consisting of (a) the largest number of registered voter votes among all the nominees, and (b) a majority of registered voter votes cast.

106. The method of claim 104, wherein two or more preliminary designated persons are selected as those who receive the largest numbers of registered voter votes in a first election, and wherein said designated person is selected as the person who receives the largest number of registered voter votes during a second election in which the candidates are said preliminary designated persons.

107. The method of claim 104, wherein n−1 groups of two or more designated person nominees are selected as those who receive the largest numbers of registered voter votes in each of n−1 intermediate voting procedures, where n is an integer, where such intermediate voting procedures are repeatedly held, each with a successively smaller number of designated person nominees, each of such successively smaller number of designated person nominees having received the largest numbers of votes in the previous voting procedure, and wherein one final designated person is selected as the person who receives the largest number of votes during a final, nth voting procedure in which the candidates are the designated person nominees selected by the last intermediate voting procedure.

108. The method of claim 103, wherein said designated person is empowered to negotiate with at least one of (a) at least one senator and (b) at least one representative, to agree upon language of proposed legislation.

109. The method of claim 86, wherein said registered voters select at least one designated position by a registered voter vote, and wherein said designated position is selected from the group consisting of:
(a) draft language of proposed legislation;
(b) changes in language of proposed legislation forming compromise language for legislation which has already been voted on;
(c) a yes/no decision relating to a legislative proposal;
(d) a yes/no decision relating to the inclusion of at least one section within a legislative proposal;
(e) a numerical value relating to a quantity within a legislative proposal; and
(f) a number which corresponds to the numerical identifier of one of a plurality of possible legislative proposals.

110. The method of claim 109, wherein said designated position is selected from a plurality of nominated positions which are nominated by said registered voters and selected by the steps of:
(a) casting and counting registered voter votes in favor of, or against a nominated position;
(b) selecting the designated position in dependence upon the number of registered voter votes in favor of such nominated position.

111. The method of claim 110, wherein said designated position is the recipient of the number of votes selected from the group consisting of (a) the largest number of registered voter votes among all the nominated positions, and (b) a majority of registered voter votes cast.

112. The method of claim 110, wherein two or more preliminary designated positions are selected as those which receive the largest numbers of registered voter votes in a first election, and wherein said designated position is selected as the position which receives the largest number of registered voter votes during a second election in which the candidates are said preliminary designated positions.

113. The method of claim 110, wherein n−1 groups of two or more first designated positions are selected as those which receive the largest numbers of registered voter votes in each of n−1 intermediate voting procedures, where n is an integer, where such intermediate voting procedures are repeatedly held, each with a successively smaller number of designated position nominees, each of such successively smaller number of designated position nominees having received the largest numbers of votes in the previous voting procedure, and wherein one final designated position is selected as the designated position which receives the largest number of votes during a final, nth voting procedure, in which the candidates are the nth designated positions selected by the last intermediate voting procedure.

114. The method defined in claim 86, wherein the registered voters cast registered voter votes using electronic communication by means of a device selected from the group consisting of (a) a computer linked to the internet, (b) a public telephone device, (c) a computer linked to a dedicated network, and (d) a private communication device.

115. A method of legislating for a legal jurisdiction, wherein a plurality of voting districts have been established within the jurisdiction, each district having a plurality of residents residing within the respective district, and each district may cast two district votes for the purpose of determining legislative decisions; wherein two representatives from each district are selected who are entitled to vote on legislation on behalf of the residents in those representative's respective district; and wherein eligible voters who have been registered within each district are entitled to vote; said method comprising the steps of:
(a) proposing legislation which, if enacted, is to be effective in the entire jurisdiction;
(b) each of a plurality of said representatives casting a representative's vote in favor of, or against the proposed legislation, thereby to reflect a voting position of each respective representative who voted;
(c) casting registered voter votes in favor of, or against the proposed legislation by each of a plurality of registered voters in at least one district;
(d) if the two representatives in a given district cast a vote and the voting position of such two representatives is the same:
(1) determining the number of oppositional registered voter votes as those registered voter votes which are in opposition to the voting position favored by said two representatives in said given district;
(2) determining the anti-representative fraction of the district vote as the number of oppositional registered voter votes divided by the number of residents in the given district;
(3) determining the pro-representative fraction of the district vote as the fraction whose numerator is (i) the number of residents in the given district minus (ii) the number of oppositional registered voter votes and whose denominator is the number of residents in the given district;
(4) counting the fractional district vote in favor of the legislation in the given district as (i) the pro-representative fraction of the district vote, if said district representatives voted in favor of said legislation and as (ii) the anti-representative fraction of the district vote, if said district representatives voted against said legislation; and
(e) if the two representatives in a given district cast a vote and the voting positions of such two representatives are opposed to each other, the fractional district vote for that district in favor of the legislation is the fraction whose numerator is the number of registered voter votes in said district in favor of said legislation, and whose denominator is the total number of residents in said district;
(f) determining the sum of all fractional district votes in favor of the legislation; and
(g) selecting a final counting method from the group of (1) the summation of fractional district votes; and (2) conversion of fractional district votes to integral district votes, followed by the summation of integral district votes;
(h) if said selected counting method is the summation of fractional votes, determining whether the proposed legislation is to be accepted in dependence upon whether the sum of the fractional district votes in favor of the legislation exceeds a prescribed percentage of the total number of district votes; and
(i) if said selected counting method is the conversion of fractional district votes to integral votes:
(1) for each district, multiplying the number of fractional district votes in favor of said legislation by the number two;
(2) for said respective district, counting said integral district vote as two votes in favor of said proposed legislation if twice said respective fractional district vote exceeds a first value, counting said integral district vote as one vote in favor of said proposed legislation if twice said respective fractional district vote exceeds a second value but does not exceed said first value, and counting said integral district vote as zero votes in favor of said proposed legislation, if twice said respective fractional district vote does not exceeds a second value; and
(3) determining whether the proposed legislation is to be accepted in dependence upon whether the sum of the integral district votes in favor of the legislation exceeds a prescribed percentage of the total number of district votes.

116. The method defined in claim 115, wherein the prescribed percentage is selected from the group consisting of (i) fifty percent and (ii) sixty-six and two thirds percent.

117. The method defined in claim 115, wherein (1) the first value is one and one third; and (2) the second value is two thirds.

118. The method defined in claim 115, wherein (1) the first value is one and one half; and (2) the second value is one half.

119. The method defined in claim 115, wherein each said representative has the additional choice of not casting a vote and wherein if one of the two representatives of a district does not cast a vote in favor of, or a vote against the legislation, the vote for that district is determined by the additional steps of:
(1) determining the number of oppositional registered voter votes as those registered voter votes which are in opposition to the voting position of said representative who votes either in favor of or against said legislation in said given district;
(2) determining the anti-representative fraction of the district vote as the number of oppositional registered voter votes divided by the number of residents in the given district;
(3) determining the pro-representative fraction of the district vote as the fraction whose numerator is (i) the number of residents in the given district plus (ii) the total number of registered voter votes in the given district minus (iii) twice the number of oppositional individual voter votes, and whose denominator is the twice the number of residents in the given district;
(4) counting the fractional district vote in favor of the legislation in the given district as (i) the pro-representative fraction of the district vote, if said voting district representative voted in favor of said legislation, and as (ii) the anti-representative fraction of the district vote, if said voting district representative voted against said legislation.

120. The method defined in claim 115, wherein each said representative has the additional choice of not casting a vote and wherein, if one of the two representatives of a district does not cast a vote in favor of or against the legislation, the vote for that district is determined by the additional steps of:
(1) determining the number of oppositional registered voter votes as those registered voter votes which are in opposition to the voting position of said representative who votes either in favor of or against said legislation in said given district;
(2) determining the anti-representative fraction of the district vote as the number of oppositional registered voter votes divided by twice the number of individual's votes cast in said district;
(3) determining the pro-representative fraction of the district vote as the fraction whose numerator is (i) twice the number of registered voter votes cast in said district minus (ii) the number of oppositional registered voter votes in said district, and whose denominator is twice the number of registered voter votes cast in said district;
(4) counting the fractional district vote in favor of the legislation in the given district as (i) the pro-representative fraction of the district vote, if said voting district representative voted in favor of said legislation, and as (ii) the anti-representative fraction of the district vote, if said voting district representative voted against said legislation.

121. The method defined in claim 115, wherein each said representative has the additional choice of not casting a vote and wherein, if neither of the two representatives of a district casts a vote in favor of or against the legislation, the vote for that district is determined by the registered voter votes cast by the registered voters of that district; wherein the fractional district vote in favor of the legislation is determined to be the fraction whose numerator is the number of registered voter votes in said district in favor of said legislation, and whose denominator is the total number of residents in said district.

122. The method defined in claim 115, wherein each said representative has the additional choice of not casting a vote and wherein if neither of the two representatives of a district casts a vote in favor of or against the legislation, the vote for that district is determined by the registered voter votes cast by the registered voters of that district, wherein the fractional district vote in favor of the legislation is determined to be the fraction whose numerator is the number of registered voter votes in said district in favor of said legislation, and whose denominator is the total number of registered voter votes cast in said district.

123. The method defined in claim 115, wherein each said representative has the additional choice of not casting a vote and wherein if neither of the two representatives of a district casts a vote in favor of or against the legislation, the vote for that district is determined by the registered voter votes cast by the registered voters of that district, wherein the fractional district vote in favor of the legislation is determined to be the fraction whose numerator is the sum of (1) the number of registered voter votes cast in the district and (2) two times the number of registered voter votes in favor of said legislation in the district, and whose denominator is the four times the total number of registered voter votes cast in said district.

124. The method defined in claim 115, wherein the registered voters vote using electronic communication by means of a device selected from the group consisting of (a) a computer linked to the internet, (b) a public telephone device, (c) a computer linked to a dedicated network, and (d) a private communication device.

125. A method of legislating for a legal jurisdiction, wherein a plurality of voting districts have been established within the jurisdiction, each district having a plurality of residents residing within the respective district, and each district may cast one district vote for the purpose of determining legislative decisions; wherein a representative from each district is selected who is entitled to vote on legislation on behalf of the residents in that representative's respective district; and wherein eligible voters who have been registered within each district are entitled to vote;
said method comprising the steps of:
(a) proposing legislation which, if enacted, is to be effective in the entire jurisdiction;
(b) casting representatives votes in favor of, or against the proposed legislation by each of a plurality of said representatives;
(c) casting registered voter votes in favor of, or against the proposed legislation by each of a plurality of registered voters in at least one district;
(d) counting the registered voter votes in said at least one district to determine the number of registered voter votes in favor of, and the number of registered voter votes against the proposed legislation in that district;
(e) in each district, determining the district vote as follows:
(1) if the number of registered voter votes in favor of the legislation exceeds a first given number for that district, that district casts one district vote in favor of the legislation;
(2) if the number of registered voter votes against the legislation exceeds said first given number for that district, that district casts one district vote against the legislation;
(3) if neither one of conditions (1) and (2) obtain, and if said representative voted for or against the legislation, then the vote of the representative is considered to be the district vote;
(4) if neither one of conditions (1) and (2) obtain, and if the representative did not vote in favor of the legislation and did not vote against the legislation, then, if the number of registered voter votes in favor of the legislation exceeds a second given number for that district, that district casts one district vote in favor of the legislation;
(5) if neither one of conditions (1) and (2) obtain, and if the representative did not vote in favor of the legislation and did not vote against the legislation, then, if the number of registered voter votes against the legislation exceeds a second given number for that district, that district casts one district vote against the legislation; and
(6) if neither one of conditions (1)-(5) obtain, then that district vote is not counted; and
(f) determining whether the proposed legislation is to be accepted in dependence upon whether the number of district votes counted in favor of proposed legislation, multiplied by the number 100, and divided by the total number of district votes counted is greater than a prescribed percentage.

126. The method defined in claim 125, wherein the first given number is equal to half the number of residents in the district.

127. The method defined in claim 125, wherein the first given number is selected from the group consisting of (i) half the number of registered voters in the district, and (ii) half the number of registered voters in the district who cast votes regarding said proposed legislation.

128. The method defined in claim 125, wherein the second given number is equal to half the number of residents in the district.

129. The method defined in claim 125, wherein the second given number is selected from the group consisting of (i) half the number of registered voters in the district, (ii) and (ii) half the number of registered voters in the district who cast votes regarding said proposed legislation, and (iii) the number one.

130. The method defined in claim 125, wherein the prescribed percentage is selected from the group consisting of fifty percent and sixty-six and two thirds percent.

131. The method defined in claim 125, wherein the registered voters vote using electronic communication by means of a device selected from the group consisting of (a) a computer linked to the internet, (b) a public telephone device, (c) a computer linked to a dedicated network, and (d) a private communication device.
